(19) United States
(12) Patent Application Publication
(10) Pub. No.: US 2026/0156532 A1
(43) Pub. Date: Jun. 4, 2026

(54) DEVICE TECHNOLOGY FORECASTING AS-A-SERVICE

(71) Applicant: AT&T Intellectual Property I, L.P., Atlanta, GA (US)

(72) Inventors: Phyllis Weiss, Englewood, NJ (US); Guang-Qin Ma, Kendall Park, NJ (US); Dongyu Lin, Holmdel, NJ (US); Veena Sharma, Warren, NJ (US); Meenakshi Kandula, Hillsborough, NJ (US); Michael Orth, Edison, NJ (US); Charles Howard, Portland, ME (US)

(73) Assignee: AT&T Intellectual Property I, L.P., Atlanta, GA (US)

(21) Appl. No.: 18/968,502

(22) Filed: Dec. 4, 2024

(51) Int. Cl. H04W 28/08; H04W 24/08; H04W 28/02

(52) U.S. Cl. CPC H04W 28/0942; H04W 24/08; H04W 28/021

(57) ABSTRACT

Aspects of the subject disclosure may include, for example, obtaining first historical data of wireless device communication technologies used to communicate with access points in a first market; obtaining information of a first characteristic of the first market; obtaining second historical data of wireless device communication technologies used to communicate with access points in a second market; obtaining information of a second characteristic of the second market; obtaining third information of a third characteristic of a third market; in a first case that the first characteristic more closely matches the third characteristic, generating based upon the first historical data a first forecast of a first mix of wireless device communication technologies; and in a second case that the second characteristic more closely matches the third characteristic, generating based upon the second historical data a second forecast of a second mix of wireless device communication technologies Other embodiments are disclosed.

### FIELD OF THE DISCLOSURE

The subject disclosure relates to device technology forecasting as-a-service.

### BACKGROUND

Mobile networks provide communication services for devices in service regions. As smart phones and other portable devices become ubiquitous, mobile networks must be expanded to accommodate growing demand. In addition, there is an increase in number and type of available communication technologies for implementing and expanding mobile network coverage and capacity.

Mobile network operators (MNOs) may operate networks over expansive territories, e.g., regionally, nationally and/or globally. According to sound business practices, MNOs may perform sales and marketing to further network utilization and/or increase revenues derived therefrom. In view of their size, geographic reach and/or varied underlying technologies, MNOs may distribute business operations across multiple business units. Each business unit may develop a particular expertise and/or insight into their respective operations collectively supporting overall operations of the MNO.

According to common practice, each of the business units may monitor their respective business activities according to one or more indicators, e.g., network utilization, revenues, numbers of subscribers, numbers and/or types of subscriber agreements, and the like. The MNO, in turn, may interpret such data to further business objectives. For example, the MNO may, from time-to-time, perform projections and/or forecasts of a business activity. Such projections may prove valuable to evaluate performance and/or to develop strategies to enhance operations.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communication network adapted to perform network traffic forecasting-as-a-service in accordance with various aspects described herein.

FIG. 2A is a block diagram illustrating an example, non-limiting embodiment of a network traffic forecasting system which can function within the communication network of FIG. 1 in accordance with various aspects described herein.

FIG. 2B is a block diagram illustrating an example, non-limiting embodiment of a tiered network traffic forecasting system which can function within the communication network and/or system of FIGS. 1 and 2A in accordance with various aspects described herein.

FIG. 2C is a block diagram illustrating an example, non-limiting embodiment of a mobile network forecasting system which can function within the communication network and/or systems of FIGS. 1, 2A and 2B in accordance with various aspects described herein.

FIG. 2D is a block diagram illustrating an example, non-limiting embodiment of another mobile network forecasting system which can function within the communication network and/or systems of FIGS. 1, 2A, 2B, and 2C in accordance with various aspects described herein.

FIG. 2E is a block diagram illustrating an example, non-limiting embodiment of yet another mobile network forecasting system which can function within the communication network and/or systems of FIGS. 1, 2A, 2B, 2C and 2D in accordance with various aspects described herein.

FIG. 2F depicts an illustrative embodiment of an example, non-limiting embodiment of a network traffic forecasting process in accordance with various aspects described herein.

FIG. 2G depicts an illustrative embodiment of an example, non-limiting embodiment of a mobile network forecasting process in accordance with various aspects described herein.

FIG. 2H is a block diagram illustrating an example, non-limiting embodiment of a forecast reconciliation processing system which can function within the communication network and/or systems of FIGS. 1, 2A, 2B, 2C, 2D and 2E in accordance with various aspects described herein.

FIG. 2I depicts an illustrative embodiment of a method in accordance with various aspects described herein.

FIG. 2J depicts an illustrative embodiment of a method in accordance with various aspects described herein.

FIG. 2K depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for generating market forecasts, such as network utilization and/or revenues, in each of a group of different markets. An accuracy of the market forecasts may be enhanced by constraining independent market forecasts in view of a forecast performed for a combination of the markets. A constraining process may include an iterative reconciliation, in which a sum of the individual market forecasts is compared to a single forecast for the combined markets. The individual market forecasts may be adjusted, combined and re-compared to the single forecast for the combined markets in an iterative manner, until some measure of the comparison, e.g., an error, is achieved within some error bound or threshold. Other embodiments are described in the subject disclosure.

One or more aspects of the subject disclosure include a device comprising: a processing system including a processor; and a memory that stores executable instructions that, when executed by the processing system, facilitate performance of operations, the operations comprising: obtaining first historical data indicative of a first mix of wireless device communication technologies that have been used to communicate with a first plurality of access points in a first market; obtaining first characterizing information indicative of a first characteristic of the first market; obtaining second historical data indicative of a second mix of wireless device communication technologies that have been used to communicate with a second plurality of access points in a second market, wherein the second market is different from the first market; obtaining second characterizing information indicative of a second characteristic of the second market; obtaining third characterizing information indicative of a third characteristic of a third market, wherein the third market is different from the first market and the second market; determining, based at least in part upon the first, second, and third characterizing information, to which of the first characteristic or the second characteristic the third characteristic more closely matches; in a first case that the first characteristic more closely matches the third characteristic, generating based at least in part upon the first historical data a first forecast of a first future mix of wireless device communication technologies that will be used to communicate with a third plurality of access points in the third market; and in a second case that the second characteristic more closely matches the third characteristic, generating based at least in part upon the second historical data a second forecast of a second future mix of wireless device communication technologies that will be used to communicate with the third plurality of access points in the third market.

One or more aspects of the subject disclosure include a non-transitory machine-readable medium comprising executable instructions that, when executed by a processing system including a processor, facilitate performance of operations, the operations comprising: obtaining first traffic flow information indicative of a first mix of end user device types that have been used to communicate with a first plurality of access points in a first market; obtaining first characterization data indicative of a first characteristic of the first market; obtaining second traffic flow information indicative of a second mix of end user device types that have been used to communicate with a second plurality of access points in a second market; obtaining second characterization data indicative of a second characteristic of the second market; obtaining third characterization data indicative of a third characteristic of a third market, wherein each of the first, second, and third markets are different markets; determining, based at least in part upon the first, second, and third characterization data, to which of the first characteristic or the second characteristic the third characteristic more closely corresponds; in a first case that the first characteristic more closely corresponds to the third characteristic, generating based at least in part upon the first traffic flow information a first forecast of a first future mix of end user device types that will be used to communicate with a third plurality of access points in the third market; and in a second case that the second characteristic more closely corresponds to the third characteristic, generating based at least in part upon the second traffic flow information a second forecast of a second future mix of end user device types that will be used to communicate with the third plurality of access points in the third market.

One or more aspects of the subject disclosure include a method comprising: obtaining, by a processing system including a processor, first time series data indicative of a first mix of end-user device wireless communication technologies that that have been used to communicate with one or more faces of a first base station in a first market; obtaining, by the processing system, second time series data indicative of a second mix of end-user device types that that have been used to communicate with the one or more faces of the first base station in the first market; obtaining, by the processing system, first information indicative of a first characteristic of the first market; obtaining, by the processing system, third time series data indicative of a third mix of end-user device wireless communication technologies that that have been used to communicate with one or more faces of a second base station in a second market; obtaining, by the processing system, fourth time series data indicative of a fourth mix of end-user device types that that have been used to communicate with one or more faces of the second base station in the second market; obtaining, by the processing system, second information indicative of a second characteristic of the second market; obtaining, by the processing system, third information indicative of a third characteristic of a third market, wherein each of the first, second, and third markets are different markets, and wherein the third market includes a third base station; determining by the processing system, based at least in part upon the first, second, and third information, to which of the first characteristic or the second characteristic the third characteristic more closely corresponds; in a first case that the first characteristic more closely corresponds to the third characteristic: generating based at least in part upon the first time series data a first forecast of a first future mix of end-user device wireless communication technologies that will be used to communicate with one or more faces of the third base station; and generating based at least in part upon the second time series data a second forecast of a first future mix of end-user device types that will be used to communicate with the one or more faces of the third base station; and in a second case that the second characteristic more closely corresponds to the third characteristic: generating based at least in part upon the third time series data a third forecast of a second future mix of end-user device wireless communication technologies that will be used to communicate with the one or more faces of the third base station; and generating based at least in part upon the fourth time series data a fourth forecast of a second future mix of end-user device types that will be used to communicate with the one or more faces of the third base station.

One or more aspects of the subject disclosure include a process that includes combining, by a processing system including a processor, multiple market-level network traffic observations of actual traffic on network resources within multiple markets to obtain a combination of actual network traffic of the multiple of markets. The process further includes generating, by the processing system, a forecast based on the combination of actual network traffic to obtain a high-level traffic forecast, generating, by the processing system, multiple market-level network traffic forecasts based on the multiple market-level network traffic observations, and combining, by the processing system, the multiple market-level network traffic forecasts to obtain a combined network traffic forecast. The high-level traffic forecast are compared with the combined network traffic forecast to obtain a first difference and, responsive to the first difference exceeding a first threshold, at least one market-level network traffic forecast of the multiple market-level network traffic forecasts are adjusted, by the processing system, according to the high-level traffic forecast, to obtain at least one adjusted market-level network traffic forecast of the multiple market-level network traffic forecasts.

One or more aspects of the subject disclosure include a device that includes a processing system having a processor and a memory that stores executable instructions. The instructions, when executed by the processing system, facilitate performance of operations. The operations include combining multiple observations of actual network traffic on network resources operating within multiple areas to obtain a combination of actual network traffic of the multiple areas. A forecast is generated based on the combination of actual network traffic of the multiple areas to obtain a high-level traffic forecast. Multiple separate area network traffic forecasts are generated based on the plurality of observations of actual network traffic and combined to obtain a combination of the separate area network traffic forecasts. The high-level traffic forecast are compared with the combination of the separate area network traffic forecasts to obtain a difference and, responsive to the difference exceeding a threshold, at least one separate area network traffic forecast of the multiple separate area network traffic forecasts is adjusted according to the high-level forecast, to obtain at least one adjusted combination of the separate area network traffic forecasts.

One or more aspects of the subject disclosure include a non-transitory, machine-readable medium, that includes executable instructions. The instructions, when executed by a processing system including a processor, facilitate performance of operations, including combining multiple observations of actual network utilization of network resources operating within multiple areas to obtain a combination of actual network utilization of the multiple areas. A forecast is generated based on the combination of the actual network utilization of network resources to obtain a baseline traffic forecast. Multiple separate area network utilization forecasts are also generated based on the multiple observations of actual network utilization. The multiple separate area network utilization forecasts are combined to obtain a combination of the separate area network utilization forecasts. The baseline traffic forecast is compared with the combination of the separate area network utilization forecasts to obtain a difference and, responsive to the difference exceeding a threshold, at least one separate area network utilization forecast of the multiple separate area network utilization forecasts is adjusted according to the baseline forecast, to obtain at least one adjusted combination of the separate area network utilization forecasts.

Disclosed herein are various examples of an automated network traffic forecasting approach that obtains actual network traffic records and input data from one or more business functions likely to impact future network traffic and prepares at least one network traffic forecast according to the actual network traffic records and/or input data. The business functions may include marketing, product development, network operations, network infrastructure planning, services, and/or other expertise as they may relate to expected changes to the network as well as sales and/or demand for a product and/or service. It is understood that the input data may encompass a scope commensurate with a segment of business that may be managed according to multiple business segments, e.g., the input data may be provided according to a regional, national and/or global business segment. In at least some instances, the input data may include further detail, such as product type, product-related technology, and/or related quality of service (QoS) related to delivery of services over the network. Alternatively, or in addition, the input data may include other supplemental information, such as overlays related to expected variations from an initial view or interpretation of the basic input data. For example, supplemental information may be provided to account for expected changes in infrastructure, new product developments, sales incentives, sunsetting of a product or service, strategic agreements that may result in efficiencies in product development, sales and/or operations, and so on.

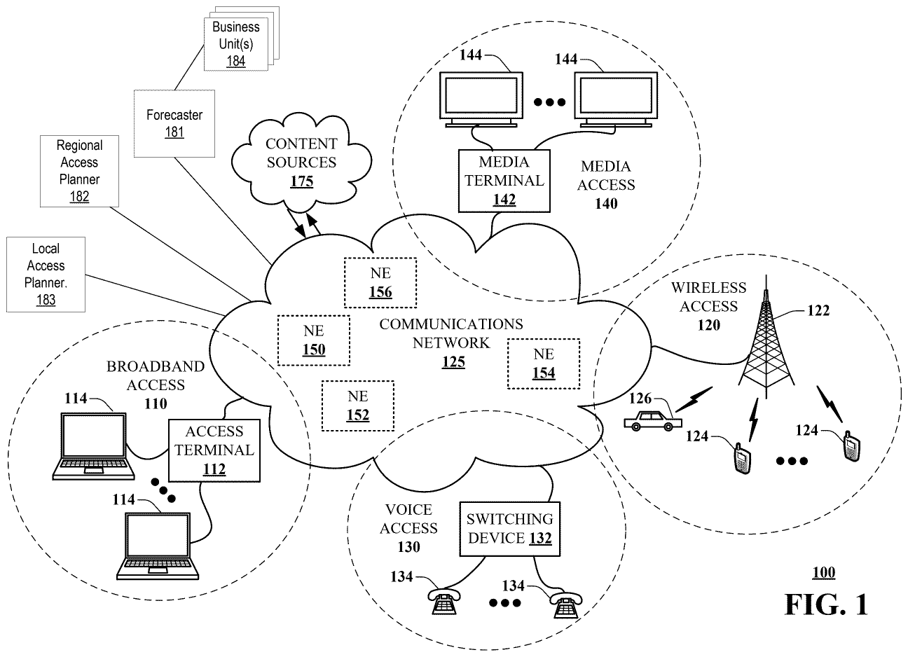

Referring now to FIG. 1, a block diagram is shown illustrating an example, non-limiting embodiment of a system 100 in accordance with various aspects described herein. For example, system 100 can facilitate in whole or in part combining multiple observations of actual network utilization within multiple areas to obtain a combination of network utilization and generating a high-level forecast based on the combination. Separate forecasts may be generated for each of the multiple areas and combined to obtain a combination of the separate area network utilization forecasts. The high-level forecast may then be compared with the combination of the separate area network utilization forecasts to obtain a difference. The difference may be compared to a threshold and, responsive to the comparison, at least one separate area network utilization forecast may be adjusted according to the baseline forecast. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

The example system 100 includes a network traffic forecaster 181 in communication with the communication network 125. The network traffic forecaster 181 may be adapted to generate one or more different types of network traffic forecasts as may be used in connection with a provision of network services via one or more of the communication network 125, the broadband access network 110, the wireless access network 120, the voice access network 130, and/or the media access network. Alternatively, or in addition, forecasts may be used in connection with provision of consumer devices, such as the example data terminals 114, the access terminal 112, the mobile device 124, the vehicle 126, the telephone devices 134, the switching device 132, the audio/video display devices 144 and/or the media terminal 142. Forecasted quantities may include, without limitation, any of the examples provided herein, such as product sales, revenue projections, data volumes, QoS, data per subscriber, volume of subscriber agreements, and the like. In at least some embodiments, forecasts may relate to sales, support and/or utilization of other consumer devices as may be used to access services via the example communications network 125 include, without limitation, connected devices, e.g., according to Internet of Things (IoT) applications, gaming systems, gaming controllers, and other devices as may be used in connection with augmented reality, extended reality and/or virtual reality applications as may be accessed and/or otherwise supported via the communications network 125.

The example system 100 may be managed by one or more example business segments 184 in communication with the network traffic forecaster 181. The business segments 184 may be part of a common business entity, e.g., a national and/or multi-national corporation operating across multiple distinguishable markets. By way of example, markets may be distinguished according to one or more of territorial boundaries, consumer types, products and/or services. It is envisioned that the network traffic forecaster 181 may be adapted to prepare network traffic forecasts to support business operations based on inputs from the different business units 184.

The example system 100 further includes a regional network resource planner 182 and a local access network planner 183. The regional network resource planner 182 may be in communication with one or more of the network traffic forecaster 181 and/or the business segments 184, e.g., via the communications network 125. The reginal network resource planner 182 may be adapted to interpret and/or otherwise utilize network traffic forecasts prepared by the network traffic forecaster 181 to further network operations of a regional network infrastructure configured to support delivery of products and/or network services to consumers. The regional infrastructure may include, without limitation, one or more of the communications network 125, the NEs 150, 152, 154, 156, the broadband access network 110, the wireless access network 120, the voice access network 130 and/or the media access network 140. Regional infrastructure planning may include sizing of network infrastructure resources based on forecasted quantities, e.g., number of subscribers, data type and/or volume, QoS, reliability. To the extent any shortfalls are identified between existing infrastructure and forecasted utilization, the regional network resource planner 182 may be adapted to identify the shortfall, e.g., according to a magnitude, a location and/or a related technology. In at least some embodiments, the regional network resource planner 182 may be adapted to quantify the shortfall and/or to provide a recommendation for reconfiguring network resources to address and/or otherwise mitigate any projected shortfall, e.g., by proposing additional resources and/or a reconfiguration and/or reallocation of existing resources, e.g., including redirecting network traffic flows or routing, to mitigate the shortfall. It is envisioned further, that in at least some embodiments, the regional network resource planner 182 may be adapted to initiate and/or otherwise facilitate implementation of any such recommendations.

The local access network planner 183 may be adapted to interpret and/or otherwise utilize network traffic forecasts prepared by the network traffic forecaster 181 to further operations of a local access network infrastructure configured to support delivery of products and/or network services to consumers. The local access network infrastructure may include, without limitation, at least portions of one or more of: the broadband access network 110; the wireless access network 120, e.g., base stations or wireless access points 122, access point sectors and/or faces, antennas, licensed frequency spectra; the voice access network 130, e.g., the switching device 132 or local exchange; and/or the media access network 140. Local access network infrastructure planning may include sizing of local access network infrastructure resources based on forecasted quantities, e.g., number of subscribers, data type and/or volume, QoS, and/or reliability. To the extent shortfalls between existing network infrastructure and forecasted utilization, the local access network planner 183 may be adapted to identify the shortfall, e.g., according to a magnitude, a location and/or a related technology. In at least some embodiments, the local access network planner 183 may be adapted to provide a recommendation for addressing and/or otherwise mitigating a projected shortfall, e.g., by proposing additional network resources and/or a reconfiguration and/or reallocation of existing network resources, e.g., including redirecting network traffic flows or routing, to mitigate the shortfall. It is envisioned further, that in at least some embodiments, the local-access network planner 183 may be adapted to initiate and/or otherwise facilitate implementation of any such recommendations.

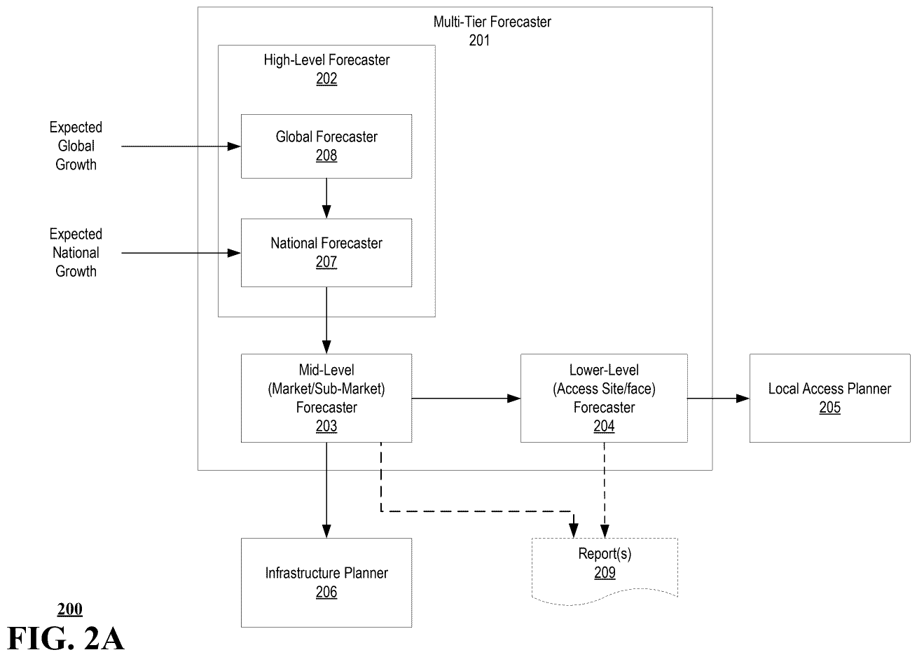

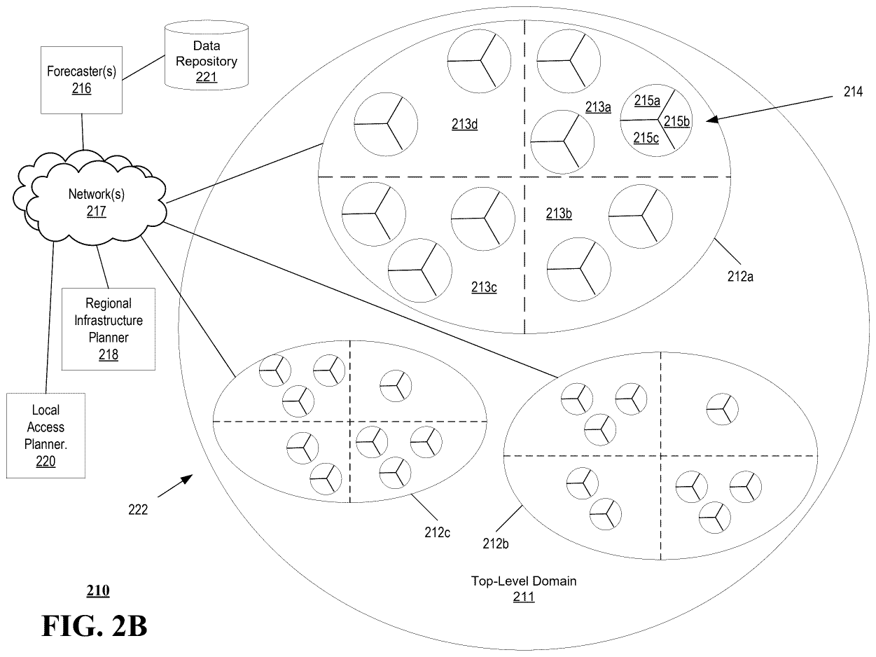

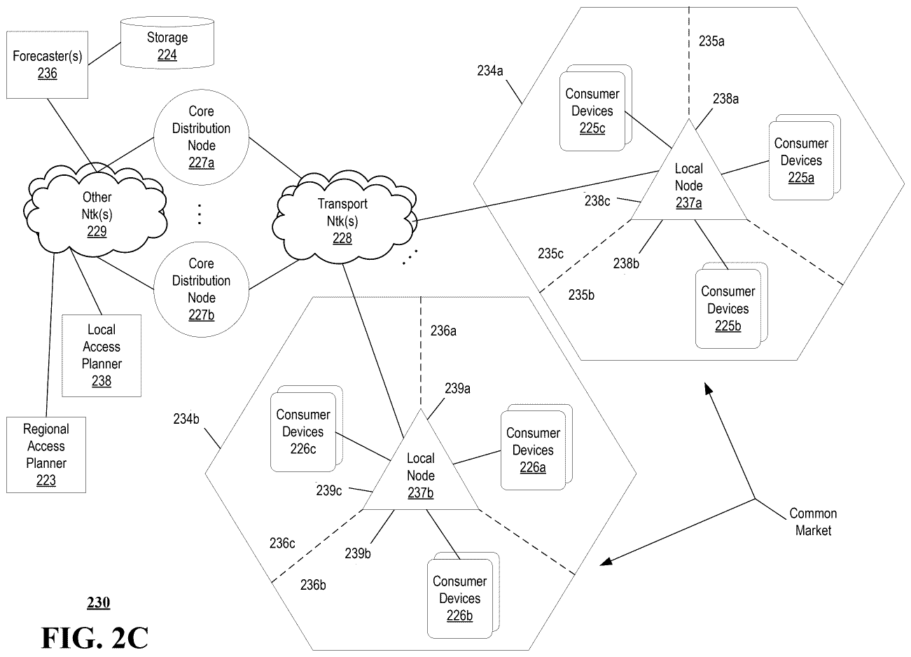

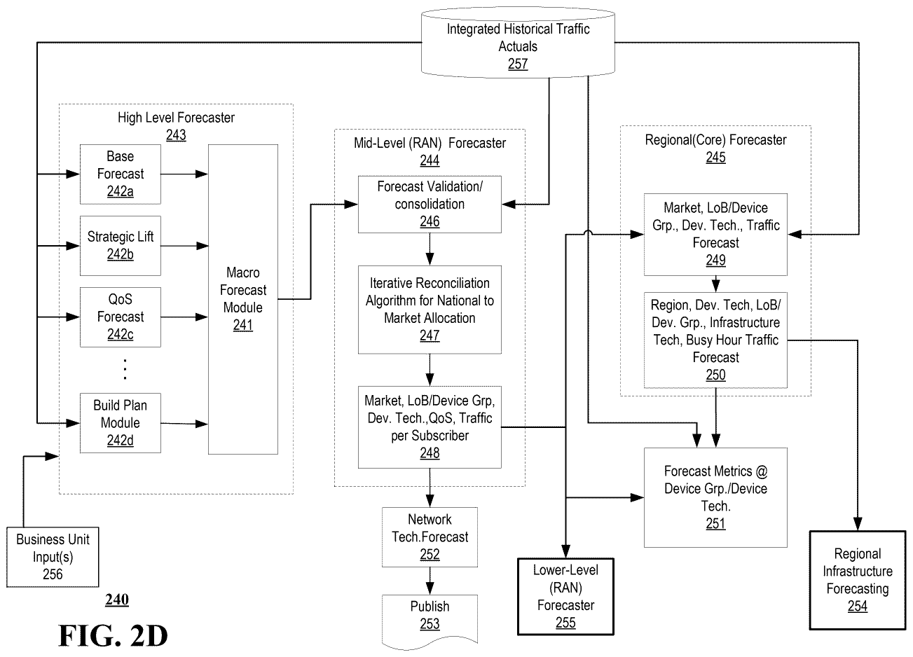

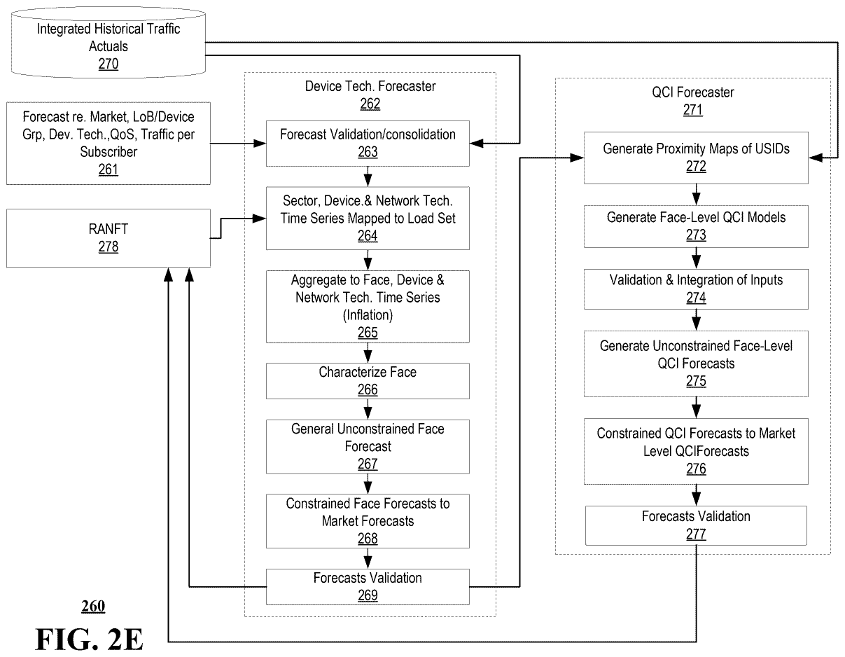

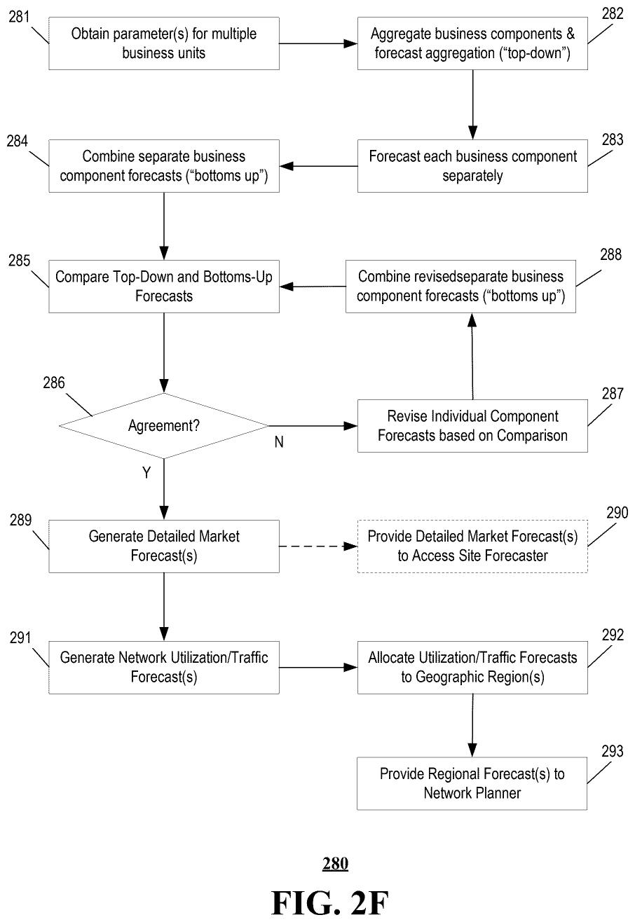

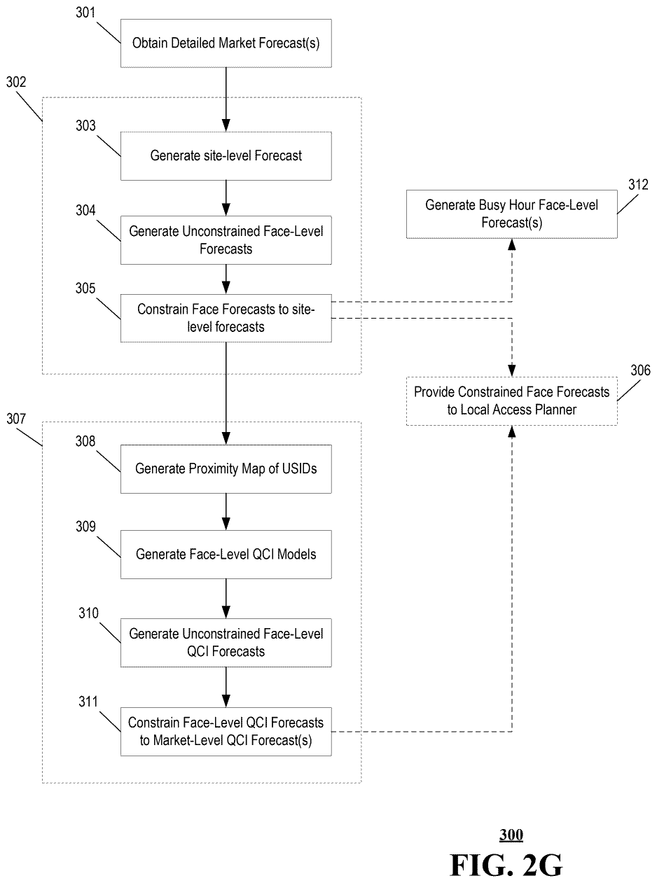

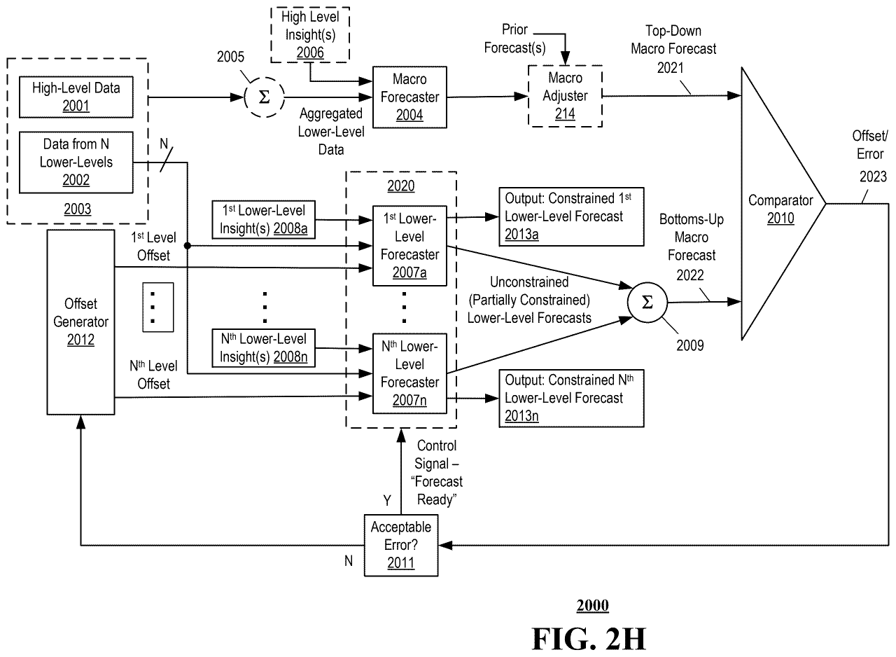

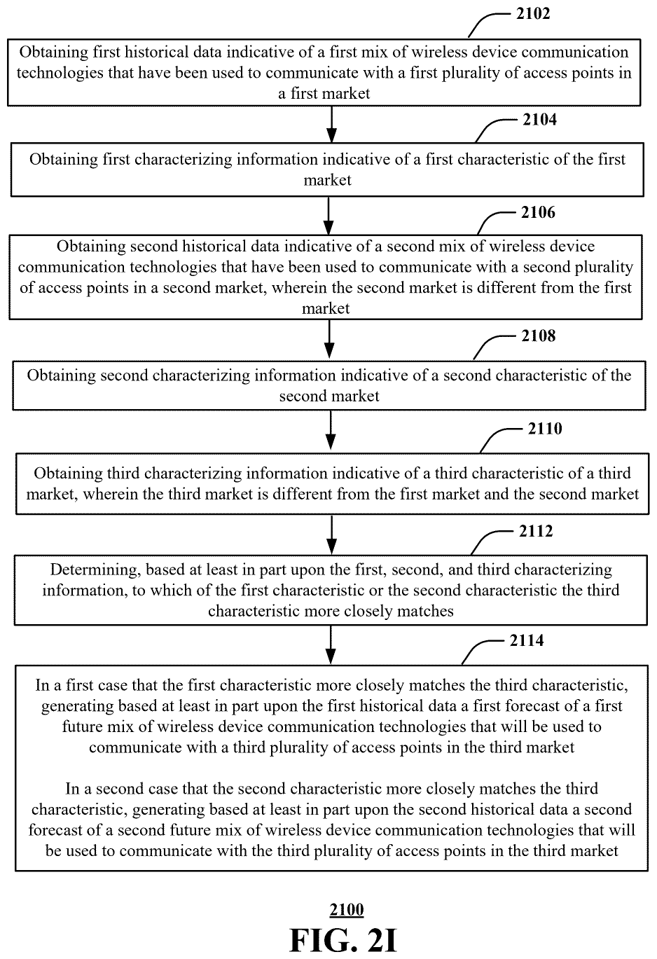

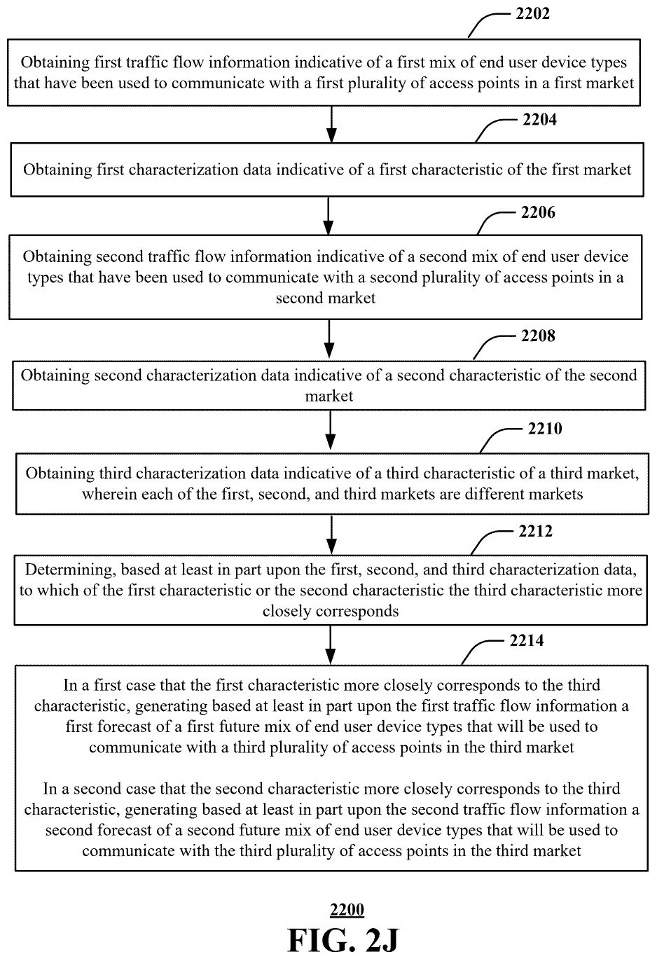

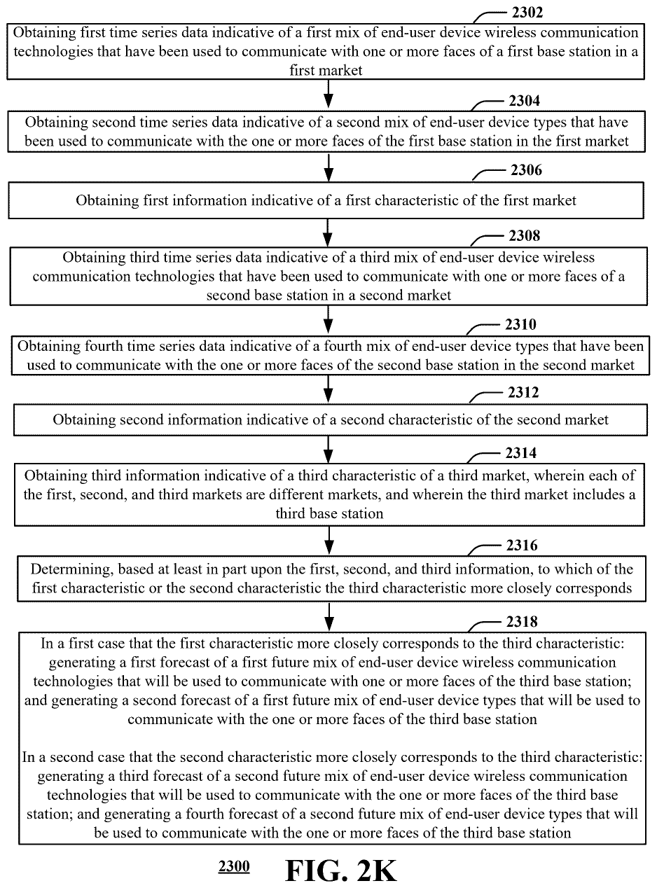

FIG. 2A is a block diagram illustrating an example, non-limiting embodiment of a network traffic forecasting system 200 which can function within the communication network of FIG. 1 in accordance with various aspects described herein. The example network traffic forecasting system 200 applies an automated market forecasting approach that obtains input data from one or more business functions and prepares at least one forecast according to the input data.

The example network traffic forecasting system 200 includes a muti-tier forecaster 201, which includes a high-level forecaster 202, a mid-level forecaster 203, and, in at least some embodiments, one or more lower-level forecasters 204. The high-level forecaster 202 receives input data from one or more business entities, such as input from sales and marketing and prepares a forecast based upon the input data. In general, the high-level forecaster 202 provides a forecast according to aggregated information, as may be related to a combination of different markets, products and/or lines of business. Many businesses, such as large telecommunication businesses, operate over expansive and varied territories, often engaging in a variety of distinguishable business activities, such as development, production, operation, maintenance, and so on. At least some businesses may collect information from the various business activities and across the various markets and to combine the information to provide insight into business operations, planning, investment, efficiencies, product development, and so on. For example, sales information and/or resource utilization may be aggregated across the business activities and/or territories to provide high-level, top-level and/or top-tier views to business managers. It is envisioned that, in at least some embodiments, the example network traffic forecasting system 200 may engage in forecasting activities related to one or more of the example business activities.

According to the illustrative example, the business may be a large national or multi-national corporation, such as a telecommunication services provider. Accordingly, the example high-level forecaster 202 may include a macro forecaster, e.g., a national forecaster 207 adapted to receive business information at a macro, e.g., national level, such as expected national growth, as may relate to a particular country. The national forecaster 207 may process the national business information to obtain one or more forecasts at a national level for the applicable country. Forecasts may include forecasted sales of new equipment and/or services, as well as revenue related to prior sales. Although reference is made herein to national forecasts, it is understood that the national forecaster 207 may operate at a regional level within a country as may be appropriate for smaller businesses that may not have a national reach.

The example high-level forecaster 202 may include a multi-national and/or global forecaster 208 adapted to receive business information according to multi-national and/or global operations, such as expected global growth. The global forecaster 208 may process the business information from multiple national markets to obtain one or more forecasts at a global level for the applicable countries within which the business operates. Once again, forecasts may include forecasted sales of new equipment and/or services, as well as revenue related to prior sales.

The high-level forecaster 202 provides one or more high-level forecasts, such as the example national and/or global forecasts. In at least some embodiments, the national forecaster 207 and/or the global forecaster 208 may access historical records of business operations. The historical records may include actuals as may relate to actual sales, revenue, volumes, and so on. In at least some embodiments, the historical records may include data according to time series, e.g., hourly, daily, monthly, quarterly, semi-annually, annually, and so on. Alternatively, or in addition, the historical records may include prior forecasts. In at least some embodiments, the national forecaster 207 and/or the global forecaster 208 may generate forecasts based on the past performance, e.g., according to trends, prior fluctuations that may correlate to identifiable situations, such as new product releases, seasonal cycles, prior and planned sales incentives, and the like.

The business functions may include marketing, product development, operations, services, and/or other business functions as they may relate to expected sales and/or demand for a product and/or service. It is understood that the input data may encompass a scope commensurate with a related business activity, e.g., the input data may be provided according to a regional, national and/or global level. To the extent network demand is a subject of a forecast, forecasted quantities may include one or more of numbers of subscribers and/or traffic volumes. In at least some instances, the input data may include multi-dimensional data that includes further detail, such as product type, product-related technology, serving network technology and/or related quality of service (QoS). Alternatively, or in addition, the input data may include other supplemental information, such as overlays related to expected variations from an initial view or interpretation of the basic input data. For example, supplemental information may be provided to account for expected changes in network infrastructure at a regional and/or site level, new product developments, sales incentives, sunsetting of a product or service, strategic agreements that may result in efficiencies in product development, sales and/or operations, and so on.

In some embodiments, the multi-tier forecaster 201 may include one or more of a high-level forecaster 202, a mid-level forecaster 203 and/or a low-level forecaster 204. In at least some embodiments, the mid-level and/or lower-level forecasters 203, 204 may provide respective mid-level and/or lower-level forecasts. Levels may relate to one or more aspects of a business, such as business organizational levels, geographical regions of operation, business divisions, business functions and/or related business entities. For example, mid-level forecast of a forecasted quantity may be determined according to respective mid-level time series data of that quantity alone or in combination with other considerations, such as corresponding sales, sales forecasts, revenues, resource utilizations, and so on. Likewise, lower-level forecast of a forecasted quantity may be determined according to respective lower-level time series data of that quantity alone or in combination with other considerations, such as corresponding sales, sales forecasts, revenues, resource utilizations, and so on. Once again, a forecast algorithm may evaluate past performance and/or trends to prepare a forecast by projecting future performance based on observed past performance and observed trends to obtain the mid-level and/or lower-level forecasts. The forecasting algorithm may take into consideration one or more other inputs identified within the marketing reports to further adjust trends according to expectations based on such other inputs as may relate to plans for launching a new product and/or sales incentive that may be expected to alter, i.e., boost sales.

It is understood that under at least some circumstances, high-level forecasts tend to be more accurate than mid-level and/or low-level forecasts, e.g., regarding long-term trends that may be overlooked and/or not readily apparent in a lower-level forecasting. This may be due, in part, to the forecasts being obtained from larger sample sizes that may be exposed to greater market variations and/or volatility. Accordingly, there may be some degree of smoothing that improves forecasts, e.g., forecasts using trend analyses of historical records. Alternatively, or in addition, there may be an enhanced degree of accuracy in a smaller market or sample size when such forecasts are based at least in part upon supplemental information that may be available for such smaller market or sample sizes. Beneficially, the example network traffic forecasting system 200 adjusts at least some forecasts to capture benefits of both the high-level forecasts and the mid-level and/or low-level forecasts.

At least one approach for determining one or more of the high-level, mid-level and/or lower-level forecasts includes an iterative approach, referred to as an iterative reconciliation algorithm. Such reconciliation between a high-level or macro forecast and a lower-level forecast imposes at least some level of agreement between an aggregated forecast and/or one or more constituent, lower-level forecasts. For example, the high-level and mid-level forecast may be obtained independently based on one or more of historical records and/or supplemental marketing input. To the extent the high-level forecast is based on a total market that represents an aggregation of constituent markets, mid-level forecasts may be obtained separately for each constituent market, then aggregated and compared to the high-level forecast. To the extent the high-level and aggregated mid-level forecasts do not agree, the mid-level forecasts may be adjusted in a manner adapted to trend a aggregation of adjusted forecasts closer to the high-level forecasts. The process may be repeated in an iterative manner until a satisfactory level of agreement is reached between the high-level and aggregated mid-level forecasts, as described in more detail below in reference to FIG. 2H.

In at least some embodiments in which a global forecast is obtained using the global forecaster 208, it is envisioned that separate national forecasts may be obtained using the national forecaster 207. The independent national forecasts may be aggregated, compared to the global forecast and adjusted in a manner adapted to reduce any disagreement between. The global-national forecasting process may be repeated in an iterative manner until a satisfactory level of agreement is achieved.

Likewise, lower-level forecasts obtained by the low-level forecaster 204 may be aggregated, compared to the mid-level forecasts obtained by the mid-level forecaster 203, adjusted and repeated in an iterative manner until a satisfactory level of agreement is achieved.

By way of example, the business may relate to a mobile network operator (MNO). Marketing data for a salesforce of the MNO may include one or more of numbers of mobile service subscribers, numbers of subscriber service plans, which may include voice and/or data that may be purchased under an agreement or plan according to a pre-paid arrangement, a post-paid arrangement or some combination thereof. The MNO may estimate projected new sales and/or subscriptions as well as existing plans and/or subscriptions. The MNO may offer mobile network services according to one or more different network technologies, e.g., GSM, UMTS, 3G, LTE, 4G, 5G and 5G-beyond. In at least some scenarios, the MNO may sell mobile devices that, in turn, may be adapted for use according one or more of the different network technologies. It is understood further, that some subscriber service plans may distinguish services from other plans, such as first-responder network services that may be provided according to a different service level agreement (SLA) that ensures network availability.

An MNO business may distinguish different markets territorially, such as a global market, national markets, regional markets, e.g., according to geopolitical boundaries of a state, a county, a municipality, and/or according to regions, such as the Northeastern US, and so on. The MNO may operate mobile network infrastructure that may include large numbers of assets, such as wireless access points, e.g., cell sites, mobile core networks, e.g., deployed regionally according to traffic demands and/or SLA requirements, and any combination of front-haul, mid-haul and/or back-haul networks as may be deployed to interconnect one or more of the assets.

It is envisioned that one or more of the lower-level marketing forecasts may be used to support a more local site level forecast as may be performed for an individual access point, e.g., a cell site and/or a sector or face of a cell site—it is understood that one cell site may be deployed to provide wireless coverage within one region that may be subdivided into sectors served by respective antenna or faces of the same cell site. In this manner, the forecasts may be used to project demand at network edges, with forecast results being passed on to site operators and/or site managers that may add and/or modify access point resources as may be necessary based on the detailed forecast.

In at least some embodiments, one or more of the lower-level forecasts may be used to develop a regional level infrastructure forecast. By way of example, the lower-level forecasts may be evaluated and/or otherwise interpreted to estimate network traffic expectations at different times of the day, days of the week, seasonal adjustments and/or event-based adjustments. In particular, the forecasts may identify and/or otherwise be interpreted to obtain those periods expected to have the greatest volume of traffic, sometimes referred to as the busy hour (BH) forecast. In that way, a back office of the MNO can plan for capacity of regional infrastructure, such as mobile core networks, transport networks, cell sites, licensed frequency spectra and the like.

In at least some embodiments, a low-level forecast obtained by the low-level forecaster may be provided to a local access network planner 205. The local access network planner 205 may operate as described for the local access network planner 183 (FIG. 1), for example, being adapted to evaluate the forecast against currently available and/or planned local access infrastructure to determine whether forecasted demand may be met with respect to anticipated QoS and/or with enough overhead. To the extent any shortfalls are identified, the local access network planner 205 may facilitate adaptations to local access infrastructure aimed at meeting forecast demand.

A site-level forecast module may utilize historical records, such as historic network traffic of a particular site, e.g., in the form of a time series of the traffic handled by that site. Such historical, site-level records may be used to evaluate and/or otherwise categorize a type of site. To an extent that the site is relatively new and/or has a limited history, records may be borrowed and/or otherwise copied from other sites. For example, traffic patterns of neighboring sites may be used in forecasts for a newer site. The historical records alone and/or in combination with marketing input may be used to obtain an unconstrained traffic forecast. Namely, the unconstrained traffic forecast may be based on the historical traffic time series as may be adjusted by marketing input. In at least some embodiments, an aggregated forecast, such as a regional forecast and/or a top-level national forecast may then be constrained to one or more lower-level market forecasts. Alternatively, or in addition, one or more of the lower-level market forecasts may be constrained according to an upper-level forecast, such as the top-level forecast. Such constraints may be imposed according to the iterative reconciliation algorithm in which agreement may be reached between an aggregated forecast and/or one or more constituent, lower-level forecasts. Similar processes may be used for other forecasts, such as the QoS forecast.

In at least some embodiments, a mid-level forecast obtained by the mid-level forecaster 203 may be provided to an infrastructure planner 206. The infrastructure planner 206 may operate as described for the regional network resource planner 182 (FIG. 1), for example, being adapted to evaluate the forecast against currently available and/or planned network infrastructure, e.g., core networks and/or transport networks, to determine whether forecasted demand may be met with respect to anticipated QoS and/or with enough overhead. To the extent any shortfalls are identified, the infrastructure planner 206 may facilitate adaptations to network infrastructure aimed at meeting forecast demand.

In at least some embodiments, forecasts and/or reports may be generated by one or more of the mid-level forecaster 203 and/or the low-level forecaster 204. It is envisioned that such reports 209 may be distributed to appropriate business entities and/or retained as part of a historical record of forecasts and/or related business information.

FIG. 2B is a block diagram illustrating an example, non-limiting embodiment of a tiered network traffic forecasting system 210 which can function within the communication network and/or system of FIGS. 1 and 2A in accordance with various aspects described herein. The tiered network traffic forecasting system 210 includes one or more communication networks 217 configured to provide one or more products and/or network services to consumers. Example networks may include, without limitation, communication networks, such as mobile networks, broadband networks, satellite service networks, cable networks, optical fiber networks. The networks may deliver products and/or services according to prescribed plans, which may identify some quantity of and/or rate for voice and/or data minutes that may be provided according to pre-paid and/or post-paid arrangements. In at least some embodiments, the prescribed plans identify a particular level of service as may be identified in a service level agreement (SLA). By way of example, levels of services may include one or more of reliability, QoS, priority access, data transfer rates, and/or bandwidth.

The example tiered network traffic forecasting system 210 includes a network traffic forecaster 216 in communication with at least one of the one or more communication networks 217. The network traffic forecaster 216 may operate as described for the network traffic forecaster 181 (FIG. 1), for example, being adapted to generate one or more different types of network traffic forecasts as may be used in connection with a provision of network services via one or more of the communication networks 217, the broadband access network 110, the wireless access network 120, the voice access network 130, and/or the media access network. In at least some embodiments, the tiered network traffic forecasting system 210 includes at least one data repository 221. The data repository 221 may be in communication with the network traffic forecaster 216 and adapted to store records as may be useful in preparing network traffic forecasts as well as storing prior forecasts. For example, the data repository 221 may be adapted to store time series records as may be used for network traffic trend analysis at mid and/or lower-level network traffic forecasts within markets, sub-markets, products and/or network services. Alternatively, or in addition, the data repository 221 may be adapted to store time series records as may relate to upper level and/or top-level network traffic forecasts as may be performed to provide an aggregated view across one or more business segments, e.g., across one or more products of a LoB and/or across multiple markets.

The example tiered network traffic forecasting system 210 also includes one or more of a regional network infrastructure planner 218 and/or a local-access network planner 220. Each of the regional network infrastructure planner 218 and/or a local-access network planner 220 may be in communication with the network traffic forecaster 216 via one or more of the communication networks 217. The regional network infrastructure planner 218 may operate as described for the regional network resource planners 182, 206 (FIGS. 1, 2A), for example, being adapted to evaluate a network traffic forecast against currently available and/or planned network resource infrastructure, e.g., core network resources and/or transport network resources, to determine whether forecasted demand may be achievable with respect to anticipated QoS and/or with sufficient overhead. To the extent any shortfalls are projected, the regional network infrastructure planner 218 may facilitate adaptations to network infrastructure aimed at meeting forecast demand. Likewise, the local-access network planner 220 may operate as described for the local access network planners 183, 205 (FIGS. 1, 2A), for example, being adapted to evaluate the forecast against currently available and/or planned local access infrastructure to determine whether forecasted demand may be met with respect to anticipated QoS and/or with enough overhead. To the extent any shortfalls are identified, the local-access network planner 220 may facilitate adaptations to local access infrastructure aimed at meeting forecast demand.

The example tiered network traffic forecasting system 210 may provide forecasts across one or more network tiers for multiple business segments or domains. The business domains may include any distinguishable domain as may be advantageous to furthering a goal of a business entity. For example, business domains may include territorial domains, LoB domains, product type domains, business operation and/or maintenance domains, manufacturing domains, distribution domains, and so on.

The example tiered network traffic forecasting system 210 is shown in relation to territorial domains 222. The territorial domains 222 include a top-level domain 211, market domains 212a, 212b, 212c, generally 212, and regional domains 213a, 213b, 213c, 213d, generally 213. The market domains 212 may include territorial markets as may be distinguished by the business entity. At least some business entities, such as national and/or multi-national business entities, may subdivide their business operations into business segments or divisions according to distinguishable markets. For example, a national business operating within the US may divide the country into multiple markets, e.g., four markets, including northeast, southeast, northwest, and southwest market domains 212. Each of the markets may be further subdivided into regional domains 213 as may be beneficial for furthering business objectives within each of the different market domains 212. For example, regions may correspond to states, counties, municipalities, and so on. Alternatively, or in addition, regions may correspond to a product and/or service distribution architecture. For example, a mobile network operator (MNO) may divide a market into regions distinguished by supporting core network resources. It is envisioned that, in at least some embodiments, the example tiered network traffic forecasting system 210 may engage in forecasting activities related to one or more of the example business activities.

According to this illustrative example, the regional domains 213 may be further subdivided according to local-access network sub-domains 214. Consider the MNO business in which the local-access network sub-domains 214 may include local access network infrastructure, such as base stations and/or wireless access points. The MNO may have deployed and/or operate multiple access points to provide a desired wireless service coverage area, e.g., approximated by the circular perimeters of the example local access network subdomains 214. It is further understood that at least some local access network subdomains 214 may be further subdivided according to local access segments, e.g., coverage segments and/or sectors of a cell. An example local access network subdomain 214, e.g., a cell site, may be subdivided into three sector domains 215a, 215b, 215c, generally 215. The sector domains 215 may relate to faces of an antenna tower outfitted with directional antennas configured to support uplink and/or downlink wireless communications with wireless devices, e.g., subscriber devices or user equipment (UE) present within their respective sector domains 215. Accordingly, in at least some embodiments, the network tiers may include one or more of a top-level domain, e.g., a global or national domain, a market-level domain, a regional domain, a local-access domain and/or a local-access sub-domain,

It is understood that forecasts of business information, e.g., sales, utilization, LoB, and the like, may be obtained at any and/or all of the example domains 211, 212, 213, 214, 215 as may be beneficial to furthering business objectives within those domains. It is envisioned that in at least some embodiments, forecasts of network traffic may be adjusted according to forecasted business information. In at least some embodiments, market level network traffic forecasts may be determined according to the example iterative reconciliation algorithm as may be constrained by a top-level domain network traffic forecast. Similarly, regional level network traffic forecasts may be determined according to the example iterative reconciliation algorithm as may be constrained by a market-level domain forecast. Likewise, local-access network traffic level forecasts may be determined according to the example iterative reconciliation algorithm as may be constrained by a market-level domain forecast. The approach may be taken even further, e.g., by determining sector or face-level network traffic forecasts according to the example iterative reconciliation algorithm as may be constrained by a local access sub domain forecast. In at least some embodiments, the forecasted business information may be applied to forecasts of any of the example domains to account for business activity that is likely to change or alter a forecast based purely on historical actual network traffic.

Business information, e.g., sales, utilization, operation costs, and so forth, may be aggregated according to any of the example tiers. Thus, regional aggregates of business information may be determined according to combinations of business information of those local access sub-domains 21 included within the regional domain 213 as may be used to offset and/or otherwise adjust any forecast obtained according to an aggregate of historical actual network traffic for the regional domain 213. Similarly, market aggregates of business information may be determined according to combinations of business information of those regional domains 213 included within the market domain 212 as may be used to offset and/or otherwise adjust any forecast obtained according to an aggregate of historical actual network traffic for the market domains 212. Likewise, a top-level market aggregate of business information may be determined according to combinations of business information of those market domains 212 included within the top-level domain 211 as may be used to offset and/or otherwise adjust any forecast obtained according to an aggregate of historical actual network traffic for the top-level domain 211.

FIG. 2C is a block diagram illustrating an example, non-limiting embodiment of a mobile network traffic forecasting system 230 which can function within the communication network and/or systems 100, 200, 210 of FIGS. 1, 2A and 2B in accordance with various aspects described herein. The mobile network traffic forecasting system 230 may include a network traffic forecaster 236, a data repository 224, a local access network planner 238 and a regional network infrastructure planner 223, each of which may operate independently and/or collectively in a similar manner to the previous example tiered network traffic forecasting system 210 (FIG. 2B). The business objectives of the example mobile network traffic forecasting system 230 correspond to those of a mobile network operator (MNO) providing mobile communication services in multiple local access regions 234a, 234b, generally 234. Each local access region 234 may be supported by a local access node, e.g., a cell tower 237a, 237b, generally 237. A first cell tower 237a operating within a first local access region 234a includes three sub-systems, e.g., faces 238a, 238b, 238c, generally 238, each extending wireless network services to wireless communication devices operating within a respective 120 deg. sector 235a, 235b, 235c, generally 235, of the full, 360 deg. local access region 234a.

The first cell tower 237a may extend wireless network services via the first face 238a to a first group of UEs 225a operating within the first sector 235a, via the second face 238b to a second group of UEs 225b operating within the second sector 235b, and via the third face 238c to a third group of UEs 225c operating within the third sector 235c. Likewise, a second cell tower 237b operating within a second local access region 234b includes three sub-systems, e.g., faces 239a, 239b, 239c, generally 239, each extending wireless network services to wireless communication devices operating within a respective 120 deg. sector 236a, 236b, 236c, generally 236, of the full local access region 234b. The second cell tower 237b may extend wireless network services via the first face 239a to a first group of UEs 226a operating within the first sector 236a, via the second face 239b to a second group of UEs 226b operating within the second sector 236b, and via the third face 239c to a third group of UEs 226c operating within the first sector 236c.

According to the illustrative example, the two local cell towers 237 may be considered by the MNO to be members of a common market, e.g., as may be distinguished by geographic location and/or according to a network architecture, e.g., both being served by common regional infrastructure, e.g., the same core infrastructure node 227 and/or a common transport network 228. The example mobile network traffic forecasting system 230 includes some number of core infrastructure nodes 227a, 227b, generally 227. Each of the core infrastructure nodes 227 may include regional network infrastructure configured to support an extension of wireless network services to one or more of the local access nodes, e.g., to the cell towers 237 according to the MNO example. For example, at least some of the core infrastructure nodes 227 may include equipment and/or cloud-based functionality, or any combination thereof, to support core mobility functions. The core mobility functions may include control plane and/or data plane functions for one or more mobile technologies, such as the various examples disclosed herein and/or otherwise generally known to those skilled in the art. For example, at least one core distribution node may be configured to provide 3G core functionality, 4G or LTE core functionality, 5G functionality, or any combination thereof. It is understood that in at least some examples, each local access node, e.g., cell tower 237, may be in communication with one core infrastructure node 227, which, in turn, may be in communication with some number of other local access nodes, e.g., cell towers 237 as may be associated with a regional domain 213 and/or market domain 212 (FIG. 2B).

According to the illustrative example, the core infrastructure nodes 227 may be in communication with the local access nodes, e.g., cell towers 237, via one or more transport networks 228. According to the MNO example, the transport networks 228 may include a front haul network, e.g., between local access network nodes, e.g., cell towers 237, a backhaul transport networks, e.g., between the core infrastructure nodes 227 and the local access network nodes, e.g., cell towers 237, mid-haul networks as may be utilized between any of the core infrastructure nodes 227 and/or the local access nodes, e.g., cell towers 237. Without limitation, the transport networks 228 may incorporate any one or more of a number of commonly used transport networks. Examples include, without limitation, cable technology, optical fiber technology, satellite communications technology, microwave technology, radio technology, including mobile cellular radio technology, and so on.

The example mobile network traffic forecasting system 230 may include one or more other networks 229, such as an operation and maintenance network, a wide area network (WAN), e.g., the public Internet, a metropolitan network, a local area network (LAN), e.g., Ethernet and/or wireless LAN, e.g., according to those addressed in IEEE 802.11 standards. Wireless services offered by the MNO may include access to resources via one or more of the transport networks 228 and/or the other networks 229, e.g., including backend servers as may extend services to wireless consumers. Subscriptions may include, without limitation, streaming services, data storage services, communication services, security services, cloud computing services, and so on.

Although the illustrative example relates to mobile network operations, it is envisioned that a similar approach may be taken with other business models, e.g., broadband services, optical fiber services, cable network services, satellite communication services, and so on.

FIG. 2D is a block diagram illustrating an example, non-limiting embodiment of another mobile network traffic forecasting system 240 which can function within the communication network and/or systems 100, 210, 230 of FIGS. 1, 2A, 2B and 2C in accordance with various aspects described herein. The mobile network traffic forecasting system 240 includes a high-level network traffic forecaster 243, a lower-level network traffic forecaster, e.g., a mid-level forecaster 244, and a regional network traffic forecaster 245. A business entity may operate according to a tiered arrangement. For example, a business entity may operate a number of sub-entities, e.g., separate divisions, that may be distinguished according to business objectives. For example, different divisions of the same company may be distinguished according to their respective markets in which goods and/or services are sold. Markets may be distinguished according to geographic territories. Alternatively, or in addition, markets may be distinguished according to lines of business (LoB), products and/or services. In at least some embodiments, the markets may be interpreted according to a tiered structure. For example, one business overview may include geographic territories as a first tier, LoB as a second tier, product type as a third tier, and so forth. Alternatively, or in addition, some markets may be further distinguished according to a refinement of subdivisions within a common category. Consider a territorial market that may be subdivided into sub-tiers or regions and possibly subdivided further, e.g., into local access zones within each region and so forth. Alternatively, or in addition, a LoB may be subdivided into product type, product technology, and so on.

In at least some embodiments, the high-level network traffic forecaster 243 aggregates and then generates a high-level forecast based on the aggregated parameter. The high-level network traffic forecaster 243, sometimes referred to as an aggregate forecaster, may combine or aggregate contributing network traffic according to a common business parameter. Values of the network traffic, e.g., according to a business parameter, may be obtained from lower-level business tiers and combined into an aggregate view of the network traffic according to the business parameter. In at least some embodiments, the business parameter provides a measure of network utilization, e.g., network traffic, data flows, data volume, data transfer rates, data types, QoS, and so on.

By way of example, a national network traffic may be determined as a sum of the network traffic obtained from different market contributors within the same country. Accordingly, the high-level network traffic forecaster 243 obtains input data from contributing sub-categories, e.g., subdivisions, of the business, then aggregates and/or otherwise sums or combines the input data from the contributing sub-categories to obtain a high-level representation of the business parameter. In at least some embodiments, the input data may relate to network traffic, e.g., historical network traffic. A network traffic value at any level may be subdivided into fractional network traffic values according to any combination of one or more business parameters. For example, a national network traffic value, e.g., thousands of gigabytes per reporting periods and/or time series step, may be associated with different network technologies, e.g., 3G, LTE and/or 5G. Accordingly, the national network traffic value may be apportioned and/or otherwise subdivided according to the different network technologies. It is understood that network traffic actuals may include details that support the different business parameters, such as subscriber detail, device type, device location, network technology, QoS, and so on.

In at least some embodiments, input data may include business units (BU) input received from one or more business units. The information may relate to one or more of sales, marketing, development, manufacturing, operation and maintenance departments of different business units of a common business entity providing business unit inputs 256. The BU input data may include any business information as may be valuable to further interests of the business entity. Example BU input data includes, without limitation, actual product and/or service sales, projected product and/or service sales, sales incentives, product types and/or mobile communication technologies supported by the product, actual and/or projected network utilization, e.g., bandwidth, data volume, call numbers and/or types, and so on. The BUs may be aligned with and/or otherwise distinguished by market types, LoBs, product types, and so on. It is envisioned that the BU input data may provide valuable insight that may be considered to adjust in a strategic manner network traffic forecasts based on historical actual network traffic values. Accordingly, history-based network traffic forecasts may be adjusted up and/or down according to insight obtained from the BU input data, to obtain a refined forecast that is expected to more closely approximate future network traffic values.

In at least some embodiments, the BU input data and/or integrated historical traffic actual data may include human-readable data or marketing reports, sometimes referred to herein as legacy reporting. Examples include, without limitation, word-formatted documents, spreadsheets, slide presentations, audio and/or video summaries, and the like, as may be commonly used within marketing organizations. By way of example, one or more marketing reports may include spreadsheets prepared according to a basic template including fields that are populated by one or more marketing organizations. More generally, the marketing organizations of a business may be distinguished according to territories, lines of business (LoB), and/or any other attribute by which business sales and/or operations may be managed. Completed marketing reports, e.g., filled-in spreadsheets, may be incorporated into automated forecasting service by automated upload.

In at least some embodiments, marketing reports may forecast and/or otherwise project expected market performance over a forecast period. Similarly, integrated historical tracking actuals may be reported and/or otherwise obtained according to a schedule. Depending upon the nature of the market, the marketing period may include some number of months, quarters, years and/or any other suitable forecast period. It is also understood that marketing reports or forecasts may include time series information at a granularity that may be finer than the forecast period. For example, a forecast period may extend for 3-5 years, while a granularity of the forecast may be provided according to a monthly, quarterly and/or semi-annual basis. It is understood that marketing reports or forecasts may be repeated from time to time. In at least some embodiments, the reports or forecasts may be repeated according to a business cycle, such as monthly, quarterly, semi-annually, annually, and so on. Likewise, historical tracking actual network traffic may be recorded from time to time, and in at least some embodiments, according to a schedule. For example, the actual network traffic recording may occur on an hourly basis, a daily basis, a weekly basis, a monthly basis, a quarterly basis, semi-annually, annually, and the like. The historical tracking actual network traffic values may be aggregated and/or interpolated as necessary for any of the comparisons and/or processing disclosed herein. Prior marketing reports and/or forecasts may also be retained in a repository or database permitting any results of those forecasts to be compared against actual marketing data, e.g., as may be obtained from actual sales of products and/or services.

In at least some embodiments, a network traffic forecast may be performed at some aggregated level, sometimes referred to as a high-level forecast or a top-level forecast. For example, historical traffic actuals and/or marketing data of a business having multiple business units and/or market segments may be obtained from each of the business units and/or market segments. In this manner, regional historical traffic actuals and/or marketing data, e.g., individual states and/or groups of states, may be aggregated to obtain national historical traffic actuals and/or marketing data. For international businesses, aggregation may be extended to obtain global historical traffic actuals and/or marketing data that includes a combination of marketing data from multiple national markets, which, in turn, may have been obtained from regional marketing reports, which may have been obtained from LoB reports, and so on.

The top-level forecast may be obtained by first aggregating historical traffic actuals and then applying a forecast algorithm to the aggregated data. For example, historical traffic actuals may include actual data observed for current and/or prior reporting periods. The historical traffic actuals and/or market data, e.g., actual values as may have been obtained from different market segments and/or LoBs, may be combined to obtain an aggregated market representative of a top-level business view. In at least some examples, the aggregated data may be presented according to a time series. In at least some embodiments, the historical traffic actuals and/or marketing data includes historical network traffic values, such that a top-level forecast may be based on an aggregation of historical network traffic across different business segments, e.g., markets. A forecast algorithm may evaluate past performance and/or trends to prepare a forecast by projected future performance based on observed past performance and observed trends.

In at least some embodiments, a forecasting algorithm may take into consideration one or more other inputs identified within the marketing reports to further adjust trends according to expectations based on such other inputs. For example, other inputs may identify plans for launch of a new product and/or a sales incentive that may be expected to alter, i.e., boost sales. According to this example, a projection based upon a trend analysis of the aggregated market data may be adjusted, e.g., increased, to account for the expected increase in sales. In this manner, the top-level forecast may incorporate such expectations with the goal of improving quality and/or accuracy of the high-level forecast.

The high-level network traffic forecaster 243 includes a macro forecast module 241 that is configured to produce a macro forecast, which also may be referred to as a high-level forecast. Information upon which such forecasts are based may relate to an organizational arrangement having multiple constituent parts. A high-level, or macro forecast may be obtained based on an aggregation and/or combination of information corresponding to at least some of those constituent parts of the organizational arrangement. Lower-level forecasts may be obtained for any number of subgroups of the multiple constituent parts. In at least some embodiments, the organizational arrangement may include two or more distinguishable levels of organization, in which instances, the lower-level forecasts may include mid-level forecasts, distinguishable from low-level forecasts. For example, high-level forecasts may be obtained based on an aggregation and/or combination of information related to the mid-level forecasts, while the mid-level forecasts may be obtained based on an aggregation and/or combination of information related to the low-level forecasts, all according to the organizational arrangement. At least one example of such an organizational arrangement includes a business entity having multiple lines of business. Each line of business may, in turn, be conducted over multiple markets, e.g., according to geographic areas or territories. Accordingly, one high-level, or macro forecast may be obtained for all lines of business over all territories, while a lower-level forecast, e.g., a mid-level forecast, may be obtained for each line of business over all territories.

It is understood that such forecasts may be obtained for any of one or more business parameters as may be useful to further a business objective, such as increasing revenue and/or supporting business operations. To this end, the example high-level network traffic forecaster 243 includes one or more of a base forecaster 242a, a strategic overlay estimator module 242b, a QoS forecaster module 242c, a build-plan module 242d. The base forecaster 242a may produce an initial forecast, sometimes referred to as a base forecast. The base forecaster 242 may obtain historical business records, e.g., historical network traffic from an integrated historical records keeper 257, such that the base forecast may be based at least in part on the historical business records. In at least some embodiments, the historical business records may be representative of a high-level or macro perspective. Alternatively, or in addition, the historical business records may be aggregated and/or otherwise combined, e.g., by the base forecaster 242a, such that the base forecaster 242a may obtain a macro base forecast. For example, the historical records may include time series records of a macro view of network traffic according to one or more business parameters, such as a parameter that may be the subject of a present forecast. Example business parameters may include, without limitation, device location, device type, device technology type, data type, application type, bandwidth, QoS, product sales, revenue projections, data volumes, QoS, data usage or volume per subscriber, numbers of subscriber agreements, and the like. Accordingly, the base forecaster 242a may generate one or more macro or aggregate forecasts based on one or more of the various record fields alone, or in any combination. In at least some embodiments, forecasts may relate to sales, support and/or utilization of other consumer devices as may be used to access services via the example communications network 125 (FIG. 1).

The base forecast module 242a may apply a forecast algorithm, such as trend analysis, to the macro or aggregated network traffic data to obtain a macro base forecast based on aggregates of historical network traffic records. The forecast may be generated according to a granularity, e.g., a time series basis that may be hourly, daily, weekly, monthly, quarterly, semi-annually and/or annually, and so on. It is understood that marketing reports or forecasts may be repeated from time to time. In at least some embodiments, the reports or forecasts may be repeated according to a business cycle, such as monthly, quarterly, semi-annually, annually, and so on. It is further understood that generated forecasts and/or otherwise projections of market performance are generated over a forecast period that may be fixed and or varied. Depending upon the nature of the market, the marketing period may include some number of months, quarters, years and/or any other suitable forecast period, such as a monthly, five-year look ahead.

For situations in which the base forecaster 242a generates a forecast, e.g., a macro forecast according to historical network traffic actuals, it is recognized that such bare projections may not include expected variations as may result from strategic business and/or market insight as may be accessible to the business units. Such strategic insight may be obtained via one or more of the business unit inputs 256. For example, the business unit inputs 256 may identify a planned launch of a new product, a new device technology, a new application and/or service and/or sales incentives. Still other insight may include recognition of seasonal variations, e.g., increased traffic during summer months near the shore, or during winter months near ski resorts. Still further insight may include recognition of events, such as anticipated network traffic surges according to scheduled conventions, educational cycles, natural business cycles, schedules of major sporting events, e.g., baseball, football, the Olympic games, the World Cup, and so on, unscheduled events, such as weather-related events, e.g., hurricanes, floods and/or wildfires. Without restriction, other examples of business insight may include a planned launch of a new service, adoption of enhanced compression algorithms, sales of new devices with new features, and/or other marketing incentives as may affect network utilization.

It is envisioned that in at least some embodiments, the base forecaster 242a may include one or more adjustments to a prediction based on historical records, e.g., actuals. Any such adjustments may be designed and/or otherwise implemented in a manner that increases and/or decreases a bare forecast to obtain a business-adjusted forecast taking into account strategic business insight. For example, a first time series containing base forecast of a network traffic without business insight may be adjusted according to a second time series containing an expected offset based on business insight. In this manner, insight into one or more factors likely to impact the base forecast may be combined according to respective time series, such that an insight-adjusted base forecast may be obtained as a combination of the time series values.

It is also recognized, however, that in at least some applications, such as the example mobile network operator application, that the aggregated forecasts, even with business insight, may be consistently off, e.g., differing by under and/or over prediction. The example strategic overlay estimator module 242b may be configured to generate an expected, estimated and/or approximated offset to a base forecast and/or to an adjusted forecast, such as the example business-adjusted forecast. For example, the strategic overlay estimator module 242b may evaluate historic actual records against prior predictions to determine variances. The strategic overlay estimator module 242b may then generate a forecast offset, e.g., lift, according to the variances, such that the base forecast, with or without business insight, may be further adjusted according to the forecast lift. In at least some instances, the forecast overlay may increase a base forecast, e.g., providing a lift, while in others, it may reduce the base forecast, or include a combination of increases and reductions across the time series of the lift-adjusted forecast.

Other factors that may contribute to any forecast of a business parameter may include anticipated infrastructure changes. For example, infrastructure changes may include enhancements to core infrastructure nodes 227, transport networks 228 and/or local access nodes, e.g., cell towers 237 (FIG. 2C). Such enhancements may identify rollout of a new network feature that may increase efficiency of network traffic, such as video compression and/or local caching of streaming media. In at least some embodiments, the aggregate or high-level market forecaster 243 includes a build-plan module 242d. The build-plan module 242d may access MNO infrastructure plans and/or schedules and generate adjustments to one or more business parameters as may relate to changes in infrastructure. For example, a first time series containing base forecast of network traffic without considering infrastructure changes may be adjusted according to a third time series containing an expected offset based on MNO insight into infrastructure plans. In this manner, insight into one or more factors likely to impact the base network traffic forecast may be combined according to respective time series, such that an infrastructure-adjusted base forecast may be obtained as a combination of the time series values. Although the example offsets may be applied by combining different time series, it is understood that in at least some embodiments, the offsets may be applied as a fixed number, a multiplier, and/or according to any other function as may be representative of any contributing factor's impact and/or contribution to a forecast.

Other forecast modules may include a QoS forecast module 242c. The QoS forecast module may be configured to generate a forecast of a network quantity, such as number of subscribers and/or network traffic according to QoS values as may impact business product and/or service offerings and/or delivery of products and/or services. It is understood that forecasts according to a measure of QoS will provide insight into network operations as may be relevant to ensuring network infrastructure is sized and configured according to such QoS forecasts. Network infrastructure may include, without limitation, cell sites, cell site sectors or faces, core networks, transport networks, and so on. To the extent that expected QoS conditions will likely result in limitations and/or improvements, an aggregate forecast QoS value may be obtained. For example, the first time series containing base forecast of a business parameter with or without considering infrastructure changes may be determined according to historically observed and/or anticipated QoS conditions.

In at least some embodiments, the high-level network traffic forecaster includes 243 a macro forecast module 241. In at least some embodiments, the forecast module 241 may perform a trend analysis at a macro level that may be based on aggregated and/or otherwise combined input parameters, e.g., using historical actual network traffic to obtain a macro network traffic demand forecast. Such long-term trend analysis may be applied to obtain a high-level, or top-down forecast control that accounts for network and handset evolution, unknown future marketing offers, network/strategic overlays (additions, subtractions, e.g., video optimization to network overlay, to forecast, e.g., raising/adjusting the bar)—stream saver, etc. It is understood that such macro demand trend analyses may be influenced by actual network demand changes and/or market events. In at least some embodiments, the macro demand trend analyses may be adjusted and/or otherwise corrected or improved based on business unit guidance. The macro forecast module 241 may obtain inputs from one or more of the base forecaster 242a, the strategic overlay estimator module 242b, the QoS forecast module 242c and/or the build-plan module 242d. The macro forecast module 241 may determine and/or otherwise adjust a base forecast obtained from the base forecast module 242a and/or the QoS module 242c according to one or more of the other modules 242b, 242d, to obtain an adjusted aggregate forecast, sometimes referred to as a high-level, top-level or macro forecast. It is envisioned that the base forecast and/or the QoS forecast may be adjusted by any suitable method, such as by combination with offset values obtained from the other modules 242b, 242d and/or by scaling and/or any other function as may approximate expected contributions from the other modules 242b, 242d.

The high-level network traffic forecaster 243 is configured to provide a forecast on business information that has been aggregated to a high, and in at least some cases, a highest level possible. It is recognized that under at least some conditions, forecast projections for aggregated information tend to be more accurate than predictions of the same parameters performed at lower levels. Thus, a forecast performed on a combination of market data across all markets may be more accurate than performing separate forecasts at each of the individual markets. That said, business objectives often require that forecast be performed at mid-to-lower levels, to facilitate proper management and/or furtherance of overall business objectives.

The mid-level network traffic forecaster 244 may be generally configured to provide and/or otherwise process mid-to-low level forecasts for individual segments of a business that may have been aggregated by the mid-level network traffic forecaster 243. In at least some embodiments, the lower-level network traffic forecaster 244 performs individual forecasts for each of the business segments to obtain a number of so-called unconstrained lower-level forecasts, e.g., one for each business segment. It is understood that in at least some instances, the high-level forecast performed on an aggregate of historical traffic data of the business segments tend to be more accurate than individual forecasts on the respective business segments. To account for improved accuracy, yet maintaining details of the individual business segments, the unconstrained forecasts obtained separately for each business segment and/or tier may be adjusted according to the high-level forecast. Adjustments of the unconstrained, lower-level forecasts may be referred to as having been constrained by the high-level forecast. It is understood that a combination or aggregation of constrained, lower-level forecasts should match and/or otherwise conform to the high-level forecast to at least within some error value or threshold value.

In more detail, the mid-level network traffic forecaster 244 includes a forecast validation and/or consolidation module 246. For efficiency and/or accuracy, the forecast validation and/or consolidation module 246 may perform a first level of pre-processing any automatically uploaded marketing reports as may obtained from the integrated historical traffic actuals repository 257. Alternatively, or in addition, the forecast validation and/or consolidation module 246 may perform a first level of pre-processing any high-level forecasts obtained from the high-level network traffic forecaster 243. For example, and without limitation, the pre-processing may apply error checking including data upload error checking and/or validation of the report inputs and/or forecast results, e.g., to detect any anomalies and to address any potential data and/or forecast quality issues. For example, reports prepared according to templates may be evaluated for completeness.

Alternatively, or in addition, uploaded reports may be evaluated for “freshness” to ensure the content is current. In at least some instances, the uploaded reports may be evaluated for consistency and/or errors. For example, entries within template fields of a marketing report may be inspected for completion and/or to ensure that any entered values are valid. Validity may be determined by comparing template data to an expected range and/or threshold. In at least some examples, entries of template fields of a market report may be compared with the same fields of another markets report, perhaps an average value obtained from a group of market reports, and/or with historical market reports to identify any unexpected variances. Any errors may be identified in a validation report for further investigation and/or returned to the marketing team for completion and/or correction. Alternatively, or in addition, any errors may be discounted, ignored, and/or otherwise populated with default data, such as a default value, a value from a prior report, a statistical value derived from historical records and/or other market data.

In at least some embodiments, the macro forecast module 241 may generate a high-level view or macro forecast, providing it to the mid-level network traffic forecaster 244, which may be configured to generate one or more mid-level forecasts. Forecasted quantities of the macro and mid-level quantities may be similar, e.g., numbers of subscribers, network traffic, QoS and so forth, to facilitate comparisons and/or additional processing. The mid-level network traffic forecaster 244 may generate forecasts of similar measures for each of a number of mid-level divisions of the high-level view. In at least some embodiments, the mid-level forecasts may include offsets and/or adjustments as previously described for one or more of the base forecaster 242a, the strategic overlay estimator module 242b, and/or the build-plan module 242d, to obtain unconstrained mid-level forecasts, which, in turn, may be adjusted and/or otherwise offset or constrained according to the macro forecast. Any of the various forecasts may include forecasts related to network traffic, such as data volume, call numbers, alone and/or in combination with other parameters, such any of the example business parameters disclosed herein.

The mid-level network traffic forecaster 244 may also include a reconciliation algorithm module 247 that is configured to perform a reconciliation of the unconstrained, lower-level forecasts to the high-level forecast. In at least some embodiments, the reconciliation algorithm may be performed in an iterative manner. For example, the multiple, unconstrained, lower-level forecasts obtained for each of the business data inputs from sub-categories may be combined to obtain an unconstrained, high-level forecast. The unconstrained high-level forecast may be compared to the high-level forecast obtained from a combination of the business data. Differences between the unconstrained, high-level forecast and the high-level forecast may be evaluated to determine an estimate of the unconstrained, lower-level forecasts. To the extent that the comparison falls within a predetermined threshold or tolerance, the unconstrained, lower-level forecasts may be validated, accepted and/or otherwise identified as constrained, lower-level forecasts. However, to the extent that comparison of a combination of the unconstrained, lower-level forecasts to the high-level forecast does not satisfy a predetermined error, the unconstrained, lower-level forecast may be adjusted by the reconciliation algorithm.

In at least some embodiments, the iterative reconciliation algorithm may be applied according to a two-way hierarchy, to obtain a time series forecast. For example, a national monthly sales total should be equivalent to a sum of market sales, e.g., as a constraint. Alternatively, or in addition, market sales should be equivalent to a sum of market product sales, as another constraint. Thus, a market forecast related to a product may be constrained by a national forecast according to multiple directions. Namely, a one-way constrained time series forecast may be obtained, e.g., for one product across all markets. Similarly, the process may be repeated for other products, e.g., combined across different products to obtain converge by way of a two-way constrained forecast. It is envisioned that in at least some embodiments, this approach may be adapted to higher dimensions.

For example, the reconciliation algorithm may identify that the combination of the unconstrained, lower-level forecasts underestimated the high-level forecast. Accordingly, the reconciliation algorithm may determine an offset for the forecasted parameter, apply the offset to one or more of the unconstrained, lower-level forecasts to obtain a partially constrained, lower-level forecast. The partially constrained, lower-level forecasts may then be combined to obtain a combined, partially constrained, high-level forecast. The partially constrained, high-level forecast may next be compared to the high-level forecast, and any differences evaluated to determine an estimate of accuracy of the partially constrained, lower-level forecasts. To the extent that the comparison falls within a predetermined threshold or tolerance, the partially constrained, lower-level forecasts may be validated, accepted and/or otherwise identified as constrained, lower-level forecasts. However, to the extent that comparison of a combination of the partially constrained, lower-level forecasts to the high-level forecast does not satisfy a predetermined error, the partially constrained, lower-level forecast may be adjusted by the reconciliation algorithm to obtain further partially constrained, lower-level forecasts. According to the reconciliation algorithm, the process may continue until the error falls within an acceptable range and/or until some maximum number of iterations is reached.

In at least some embodiments, the mid-level network traffic forecaster 244 includes a forecast post-processing module 248. The forecast post-processing module 248 may include post-processing that is configured to parse, arrange and/or otherwise rearrange the constrained, mid-level forecasts according to one or more business objectives or business parameters to obtain targeted business forecasts. As the forecasted data may be multi-dimensional, the post-processing module 248 may further parse the constrained mid-level forecast, e.g., according to one or more of a market, a LoB, a device group, a device technology, a QoS. By way of example, the constrained, lower-level forecasts, e.g., market-level network traffic forecasts may be allocated and/or otherwise arranged according to one or more business parameters, such as LoBs, mobile device groups, mobile device technologies, QoS, traffic per subscriber, and so on. In at least some embodiments, the post processing may combine forecasts of numbers of subscribers with network traffic, e.g., to obtain forecasted network traffic per subscriber.

In at least some embodiments, one or more of the unconstrained, lower-level forecasts and/or one or more of the business objective forecasts may be provided to a network technology forecasting system 252. The network technology forecasting system 252 may be configured to organize, interpret and/or otherwise, process the constrained, lower-level forecasts as may be applicable to evaluating sufficiency of network resources of the MNO. It is envisioned that in at least some embodiments, one or more of the various forecasts disclosed herein may be published to reports 253 and/or provided to the integrated historical traffic actuals repository 257.

Alternatively, or in addition, one or more of the unconstrained, lower-level forecasts and/or one or more of the business objective forecasts may be provided to another lower-level forecaster, e.g., a low-level or according to the example embodiment a site-level forecasting system 255. For example, the site-level forecasting system 255 may be configured to implement one or more forecast validation and/or consolidation for the unconstrained, lower-level forecasts and/or business objective forecasts. Alternatively, or in addition, the site-level forecasting system 255 may be configured to implement another iterative reconciliation algorithm, e.g., configured to generate one or more site-level forecasts of the applicable business parameter(s) in a constrained manner, according to a respective mid-level or other lower-level forecast. For example, the constrained, lower-level forecast may correspond to a mid-level market forecast, in which instance, an aggregate of unconstrained site-level forecast of a region or market is compared to a market level forecast. In at least some embodiments, the market level forecast may be based on the constrained, market-level forecast. The unconstrained site-level forecast may be constrained according to observed differences between the aggregated site-level forecast and market level forecast, e.g., using any of the various iterative reconciliation techniques disclosed herein.

It is envisioned that in at least some embodiments, the site-level forecasting system 255 may be configured to apply yet another level of subdivision and/or refinement, e.g., obtaining multiple constrained, face-level forecasts for each constrained, site-level forecast. A similar approach may be followed at each level of refinement, e.g., performing forecast validation and/or consolidation of higher-level forecasts, then applying an iterative reconciliation algorithm.

Alternatively, or in addition, lower-level market forecasts may be performed independently for any one or more of the marketing reports that may be aggregated to obtain a top-level business view. For example, market forecasting may be applied separately to each of several different territorial regions within which a business operates, e.g., states and/or groups of states. Alternatively, or in addition, market forecasting may be applied separately according to different business units and/or LoBs within which a business operates, e.g., according to a particular product, product line and/or class of products or services. Accordingly, separate forecasts may be obtained for each of several business views.

According to the automated market forecasting approach disclosed herein, the forecasts, e.g., one or more of the top-level and/or the lower-level forecasts, may be improved by application of an iterative reconciliation algorithm. For example, the iterative reconciliation algorithm may allocate the top-level forecast to one or more of the lower-level forecasts. In at least some embodiments, an allocation of the top-level forecast may be based on historical time series at the lower levels. In a similar manner, the iterative reconciliation algorithm may be used to further distribute a forecast to one or more lower levels. Thus, a top-level global or national forecast may be allocated down to regional markets and, in at least some embodiments, one or more of the regional market forecasts may be distributed to one or more lower-level forecasts, such as LoB forecasts, product and/or service type forecasts, product and/or service technology forecasts, QoS forecasts, and in at least some embodiments, calculating and/or otherwise estimating a demand per consumer or subscriber.

In at least some embodiments, the mobile network traffic forecasting system 240 may include a regional network traffic forecaster 245 adapted to forecast and/or otherwise arrange network traffic forecasts according to regional network infrastructures. For example, the regional network traffic forecaster 245 may be configured to generate time series network traffic forecasts and/or to determine and/or otherwise estimate busy-hour network traffic at one or more regions, e.g., regions of a network domain or architecture.

In more detail, the regional network traffic forecaster 245 may include a forecast refinement module 249. The forecast refinement module 249 may include post-processing that is configured to parse, arrange, refine and/or otherwise rearrange the constrained, lower-level forecasts according to one or more business objectives or business parameters to obtain refined targeted business forecasts. Alternatively, or in addition, the regional network traffic forecaster 245 may simply receive constrained, lower-level forecasts, e.g., market-level network traffic forecasts may be allocated and/or otherwise arranged according to one or more business parameters, such as LoBs, mobile device groups, mobile device technologies, QoS, traffic per subscriber, and so on, from the forecast refinement module 248 of the mid-level network traffic forecaster 244. To the extent that extension and/or modifications to the refined targeted business forecasts are required by the regional network traffic forecaster 245 to obtain further refined targeted business forecasts, the forecast refinement module 249 may determine such further refinements and/or extensions according to input data received from the forecast refinement module 248 and/or from the integrated historical records keeper 257.

In at least some embodiments, the regional forecaster 245 also includes a regional infrastructure forecaster 254. The regional infrastructure forecaster may process the further refined targeted business forecasts to obtain time series forecasts and/or busy hour projections associated with one or more aspects of a regional network infrastructure. It is envisioned that in at least some embodiments, forecasts may be determined separately for uplink communications, e.g., from a mobile device to a wireless access point and conversely for downlink communications, e.g., from the wireless access point to the mobile device.

In at least some embodiments, the mobile network traffic forecasting system 240 includes a regional infrastructure forecasting module 254. It is envisioned that in at least some embodiments, the regional infrastructure forecasting module 254 may evaluate projected network traffic, including, where available, time series data and/or busy hour projections. The regional infrastructure forecasting module 245 may also include a regional infrastructure evaluation module 250 that is configured to parse, refine, rearrange and/or otherwise interpret refined reports obtained from one or more of the forecast refinement modules 248, 249. In at least some embodiments, the regional infrastructure forecasting module 254 may generate forecasts adapted for interpretation and/or analysis at a regional infrastructure level. For example, in at least some embodiments, the generated forecasts may include so-called busy-hour forecasts that may be used to ensure that regional infrastructure provides sufficient capacity and/or overhead to accommodate anticipated busy hour traffic situations. The term busy hour traffic situations suggest maximum loads to which network infrastructure and/or routing configurations may be adapted.

In some embodiments, the busy hour forecasts may be determined by observing time series network records performed at sufficient resolution to distinguish a time varying load within a relatively narrow time window, such as a daily cycle. Alternatively, or in addition, such busy hour metrics may be obtained from coarser time-based records, e.g., by applying an offset, e.g., a multiplier, and/or determining an average, e.g., a daily average, then apportioning the daily average to a busy hour metric. Alternatively, or in addition, network traffic metrics may be interpolated to obtain refined values that may be used as is and/or further manipulated to obtain an estimate of a busy hour condition.

In at least some embodiments, the mobile network traffic forecasting system 240 includes a detailed, forecast metrics module 251. The detailed forecast metrics module 251 may obtain forecasts from one or more of the mid-level forecast refinement module 248, the regional forecast refinement module 249 and/or the infrastructure evaluation module 250. The detailed, forecast metrics module 251 may apply, alone or in combination, any of the various forecasting techniques disclosed herein and/or otherwise generally known to those skilled in the art. For example, the detailed, forecast metrics module 251 may arrange forecasts according to one or more dimensions of forecasted multi-dimensional data. Alternatively, or in addition, the detailed, forecast metrics module 251 may apply post processing to forecasts. Post-process may include, without limitation, arranging forecasts according to one or more dimension of the multidimensional data, combining and/or otherwise interrelating forecasted quantities.

The example mobile network traffic forecasting system 240 may be automated in part or in whole. For example, the mobile network traffic forecasting system 240 can be configured to automatically perform anomaly detection on historical actual records as may be retrieved from the integrated historical traffic repository 257. Alternatively, or in addition, error checking may be applied to any input data retrieved, received and/or otherwise obtained by the mobile network traffic forecasting system 240. According to the example mobile network traffic forecasting system 240, an iterative reconciliation algorithm may be applied.

It is envisioned that in at least some embodiments, one or more of data proxies and/or data transformations may be applied as may be beneficial in performing any of the example forecasting and related processing disclosed herein. According to data proxies, data may not be available for a particular network entity, business parameter, sales and/or marketing data, site and/or face level data, subscriber data, device type, technology type and the like. In such instances, a reasonable substitute of another particular network entity, business parameter, sales and/or marketing data, site and/or face level data, subscriber data, device type, technology type and the like, may be considered as a proxy and used in any of the example forecasting and/or related techniques disclosed herein.

It is envisioned that input data obtained from data repositories, forecast processing modules, user input, business unit input and the like may not be presented in a most convenient form. In such instances, example mobile network traffic forecasting system 240 may apply one or more data transformations as may be necessary to initiate, perform and/or otherwise utilize and/or interpret forecasted results.

By way of example, one or more techniques may be applied to one or more of the example processing techniques disclosed herein. For example, exponential smoothing may be applied, e.g., to input actuals, generated forecasts, time series data, and the like. Alternatively, or in addition, locally-weighted smoothing may be utilized as another technique. In at least some embodiments, other techniques may be applied, such as mean absolute percentage error (MAPE) calculations, and/or weighted MAPE (wMAPE) calculations, as may be beneficial in obtaining the various forecasts disclosed herein and/or in presenting and/or storing records of such forecasts.

It may be appreciated that the various techniques disclosed herein may be applied to improved forecast quality and/or forecast cycle time, e.g., for downstream capacity planning. Other benefits may include at least some level of automation in managing network resources, such as mobile core networks and/or access nodes, e.g., cell sites, as well as faces of a cell site supporting uplink and/or downlink mobile communications according to allotted sectors of the site.

FIG. 2E is a block diagram illustrating an example, non-limiting embodiment of yet another mobile network site forecasting system 260 which can function within the communication network and/or systems of FIGS. 1, 2A, 2B, 2C and 2D in accordance with various aspects described herein. The example mobile network site forecasting system 260 may be configured to provide forecasts of one or more network related parameters as may be relevant to designing, provisioning, configuring, operating and/or maintaining network access nodes. To that end, the mobile network site forecasting system 260 may include a device technology forecaster 262 configured to forecast one or more network parameters according to one or more site parameters.

The device technology forecaster 262 may include a forecast validation and/or consolidation module 263 that may receive inputs from one or more of an integrated historical traffic actuals repository and/or a market and/or regional network traffic forecaster 261. Input data may include actual, observed network metrics, such as network traffic, device location, device type, device technology, QoS, and so on. In at least some embodiments, any of the example data described herein may be adjusted for privacy and/or security. For example, subscriber data may be scrubbed and/or aggregated to ensure subscriber privacy. The validation and/or consolidation module 263 may perform a validation and/or consolidation of any of the various input values according to any of the example validation and/or consolidation techniques disclosed herein and/or otherwise generally known to those skilled in the art.

The validated and/or consolidated output may be provided to a forecast processor 264. The forecast processor 264 may rearrange, adjust, and/or otherwise parse one or more fields of the validated and/or consolidated output. In at least some embodiments, the fields include time series data as may have been obtained from the integrated historical traffic actuals repository 270, via the forecast validation and/or consolidation module 263. For example, output of the validated and/or consolidated module 263 may include a forecast for a particular access node or cell site 237 (FIG. 2C). The forecast processor 264 may identify network traffic, subscriber, device type, device technology, device location, QoS, service, data and/or application type, associated access point name and so on. The forecast processor 264 may process the validated forecast and/or consolidated output to allocate and/or otherwise arrange the forecasted parameters according to one or more of the parameters. For an example cell site 237 having multiple faces 238 (FIG. 2C), separate unconstrained forecasts, e.g., of numbers of subscribers and/or network traffic may be obtained for one or more of the multiple faces 238. In at least some embodiments, the forecast processor 264 may receive input data from an access site planner system 278, which may provide details regarding one or more access sites, e.g., supported technologies, power levels, locations, numbers of sectors, face level information and the like.

In at least some embodiments, the device technology forecaster 262 may include a cell site face characterization module 266. For example, the cell site face characterization module 266 may implement a characterization algorithm to capture one or more aspects of one face that may differ from another face. The device technology forecaster 262 may include a general unconstrained face forecaster 267 adapted to provide one or more forecasts of one or more network parameters, e.g., network traffic, for one or more faces of an access node. Such unconstrained forecasts may be based upon actual information obtained from the integrated historical traffic actuals repository 270. The cell site face characterization module 266 may apply some function and/or algorithm to the unconstrained face forecasts to improve the forecasts by accounting for face features that may enhance and/or hinder network communications.

The device technology forecaster 262 may include a constrained face forecast module 268. The constrained face forecast module 268 may apply a higher level forecast, such as a market forecast as may be obtained from market and/or regional network traffic forecaster 261, to constrain the unconstrained face level forecasts. For example, the unconstrained face level forecasts may be aggregated according to a cell site and/or a region, and/or a market. The aggregated forecasts may be compared to a forecast of the aggregated information, e.g., an entire market, region and/or site forecast. To the extent the two do not agree to within some tolerable error, adjustments may be made to the unconstrained face level forecasts, and the aggregate-comparison process repeated in an iterative manner until a satisfactory agreement is obtained. In at least some embodiments, forecasts obtained in this manner may be validated according to the example forecast validation module 269.

In at least some embodiments, the device technology forecaster 262 may include an offset module 265. The offset module may be adapted to introduce a forecasting factor related to an anticipated offset due to a new and/or changed circumstance that may not have been accounted for in historical data records. For example, instruction of a new type of mobile device and/or service, a new service plan, a new network configuration and/or traffic routing, may affect a forecasted quantity. For example, a mobile network operator may choose to generate a forecast related to 5G traffic, in the absence of 5G device history. The offset module 265 may be configured to anticipate that future 5G traffic will be greater than 4G traffic. In at least some instances, the offset module 265 may generate an offset, such as an “inflation” factor that may be applied to the 5G forecast in the absence of 5G historical records. It is understood that the offset module 265 may be configured for other forecasts of subscribers and/or volumes of network traffic in view of other new technologies, such as 6G, smart cars, augmented reality/virtual reality (AR/VR), applications, e.g., the metaverse, and so on.

Validated site and/or face level forecasts may be provided to the access site planner system 278. The access site planner system 278 may be configured to compare site and/or face level forecasts to installed, operational and/or planned site and/or face level infrastructure. The MNO may realize valuable insight from such comparisons as may be used to drive site management, e.g., site expansions, site reconfigurations, site decommissioning, acquisition and/or management of licensed frequency spectra, management of operational power levels, and so on.

Access nodes may be in communication with regional network infrastructure, e.g., transport networks and/or mobile core networks, and otherwise configured to extend communications services to end user equipment or devices. It is understood that access nodes may include, without limitation, wireless communication services, such as mobile cellular base station services. More generally, the access nodes may utilize one or more wireless communications technologies, such as mobile cellular technologies according to one or more mobile technology standards, e.g., any of the various example mobile communications standards disclosed herein and/or otherwise generally known to those skilled in the art. Alternatively, or in addition the wireless communications technologies, may include one or more of radio frequency technologies, microwave technologies, millimeter wave technologies, free space optical communication technologies, infrared communication technologies, acoustical communication technologies, satellite communication technologies and so on.

Alternatively, or in addition, the access nodes may include, without limitation, tethered communication technologies, such as copper twisted pair, coaxial cables, cabled network technologies, powerline communications, optical fiber communications and so on. It is worth noting here that although many of the examples disclosed herein relate to communications networks and/or network traffic, the forecasting and/or analysis techniques disclosed herein may be applied to other applications, such as energy distribution networks, e.g., the electrical power grid, and/or natural gas transport systems. Still other applications may include other municipal services, such as water services, sewer services, and/or any other smart city applications, such as smart roadways. Each of these types of systems may be operated over multiple regions, incorporate a regional resource distribution and/or management system, and/or include access nodes provided in close proximity to consumers to provide access to the various services.

The example mobile network site forecasting system 260 also includes a QoS Class Identifier (QCI) forecaster 271. The QCI forecaster 271 may include a proximity mapper 272. The proximity mapper 272 may receive input data from one or more of the validated forecasts from the forecast validation module 269 of the device technology forecaster 262. The validated forecasts may include site level and/or face level forecasts. Alternatively, or in addition, the proximity mapper 272 may obtain one or more records from the integrated historical traffic actuals repository 270. The proximity mapper 272 may generate one or more proximity maps based on the validated site and/or face level forecasts and/or from integrated historical traffic actuals data. The proximity maps may identify USIDs proximity to a particular location and/or region, such as a cell site, a face, a cell coverage area and/or sector, and the like (a USID, or Universal Site Identifier, can be used to identify cell sites with a unique integer value assigned to a location where one or more mobile base stations can be located).

The proximity maps of USIDs may be provided to a face-level QCI modeler 273 configured to generate face-level QCI models based on the USID proximity maps. The example QCI forecaster 271 may include an input validation and/or integration module 274. The input validation and/or integration module 274 may be configured to validate and/or otherwise integrate input data from one or more of the face-level QCI models and/or the proximity maps of USIDs, and/or forecasts obtained from the forecast validation module 269 of the device technology forecaster 262 and/or the integrated historical traffic actuals repository 270.

In at least some embodiments, the validated and/or integrated input data may be provided to an unconstrained, face-level QCI forecaster 275. The unconstrained, face-level QCI forecaster 275 may be configured to provide one or more forecasts of one or more network parameters, e.g., QCI, for one or more faces of an access node. The QCI forecaster 271 may include a constrained QCI forecast module 276. The constrained QCI forecast module 276 may apply a higher level forecast, such as a market forecast as may be obtained from market and/or regional network traffic forecaster 261, to constrain the unconstrained face level forecasts. For example, multiple face-level QCI forecasts of a cell site, a region and/or a market may be considered collectively and/or otherwise combined for the cell site, the region, and/or the market. The aggregated forecasts may be compared to a forecast of the aggregated information, e.g., an entire market, region and/or site forecast. To the extent the two do not agree to within some tolerable error, adjustments may be made to the unconstrained face level forecasts, and the aggregate-comparison process repeated in an iterative manner until a satisfactory agreement is obtained. In at least some embodiments, forecasts obtained in this manner may be validated according to the example forecast validation module 277.

The example mobile network site forecasting system 260 may be automated in part or in whole. For example, the mobile network site forecasting system 260 can be configured to automatically perform anomaly detection on historical actual records as may be retrieved from the integrated historical traffic repository 257. Alternatively, or in addition, error checking may be applied to any input data retrieved, received and/or otherwise obtained by the mobile network site forecasting system 260. According to the example mobile network site forecasting system 260, an iterative reconciliation algorithm may be applied.

Other algorithms, techniques and/or automation may be applied to observe, impose and/or otherwise identify time series seasonality. Such seasonality may be obtained by decomposition and/or detection. Other data processing techniques that may be used in interpreting, forecasting, predicting and so on may include any combination of one or more of: regression techniques; exponential smoothing; kernel method for local weights; distributed lag and/or auto-regressive model; moving average trending; nearest neighbor pooling for robust trending; generalized additive models; locally polynomial quantile regression; ensemble models, and so on.

The device technology forecaster 262 can be used, for example, in connection with various device technology forecasting embodiments described herein.

FIG. 2F depicts an illustrative embodiment of an example, non-limiting embodiment of a network traffic forecasting process 280 in accordance with various aspects described herein. According to the example network traffic forecasting process 280, one or more input parameters are obtained at 281 from different business units of a common business entity. The input parameters of each business unit may be referred to as component parameters and/or input values according to sub-categories. The component input parameters may relate to business objectives as may be forecasted and promulgated withing the business entity to facilitate achievement of a business objective, e.g., increasing revenue, reducing expenditures, enhancing efficiency, increasing market share, improving quality, and so on.

The component parameters are aggregated and/or otherwise combined at 282 to obtain a high-level combination of the component parameters or input values according to sub-categories. For example, each of the component parameters may correspond to a respective business unit, e.g., a particular market, LoB, product line, and so on, such that the high-level combination represents a total parameter value as may be relevant to the business entity as a whole. In at least some embodiments, a high-level forecast is obtained based on the high-level combination of the parameters. The high-level forecast may be referred to as a “top-down” forecast. The high-level forecast may be generated according to any predictive algorithm described herein and/or otherwise generally known to those skilled in the art. It may be appreciated that in at least some circumstances, high-level forecast may be less useful to each business unit than a forecast of the component parameter for that business unit.

According to the example process 280, separate, component-level forecasts may be obtained for each of the component parameters at 283 to obtain a group of component-level forecasts. It is envisioned that at least some of these component-level forecasts may be generated according to any predictive algorithm described herein and/or otherwise generally known to those skilled in the art. In at least some embodiments, the same predictive algorithm may be applied at steps 282 and 283, however, it is envisioned that in at least some embodiments, different algorithms may be applied.

The separate component-level forecasts are combined at 284 to obtain an unconstrained high-level forecast, sometimes referred to as a “bottoms up” forecast. The top-down forecast is compared to the bottom-up forecast at 285. The comparison may include determining a difference between the forecasts. As the forecasts may contain time series, the difference may be computed as a time series, identifying the difference at each time step. Alternatively, or in addition, the difference may be determined by one or more of a mean difference over a forecast sample that may include multiple time steps.

A determination is made at 286 as to whether there is agreement between the top-down and bottoms-up forecasts. For example, the difference obtained at 285 may be considered as an error that may be compared to a threshold, e.g., some value of tolerable error. To the extent the error exceeds the tolerable threshold, it may be determined at 286 that there is insufficient agreement. In such instances, one or more of the individual component forecasts may be adjusted and/or otherwise revised at 287. The revisions may be determined in a manner adapted to improve the chances of agreement for a subsequent comparison. Namely, the revised individual component forecasts may be combined at 288 to obtain a revised bottoms up forecast that may be compared to the top-down forecast at 285 to obtain an updated comparison. The updated comparison may be evaluated in terms of the error criteria to determine at 286 whether the forecasts agree.

To the extent it is determined at 286 that the bottoms up forecast and/or the revised bottoms up forecast agree with the top-down forecast, the process 280 may record the revised individual component forecasts and/or generate one or more detailed component forecasts at 289 (shown in phantom). The revised individual component forecasts at the time agreement is determined at 286, may be referred to as constrained, component forecasts, e.g., suggesting that the component forecasts have been constrained according to the top-down forecast. To the extent that the components relate to markets, detailed market forecasts may be determined at 289 according to the last revised individual component forecasts. In at least some embodiments, the detailed market forecasts may be provided to an access site forecaster at 290 (shown in phantom). The access site forecaster, in turn, may be adapted to implement a similar iterative process to further subdivide each detailed market forecast into regional and/or access site level forecasts as may apply to each of the different markets.

According to the example process 280 and in at least some embodiments, network utilization and/or traffic forecasts may be obtained at 291 according to the detailed market forecasts obtained at 289. For example, an estimate of data and/or voice traffic, e.g., volume and/or hourly forecasts may be obtained according to the detailed market forecasts.

To the extent that any network utilization and/or traffic forecasts are obtained at 291, they may be used to allocate traffic forecasts to geographic regions at 292. The geographic regions may correspond to a network architecture employed by an MNO. For example, the geographic regions may correspond to location codes (LAC) and/or tracking area codes (TAC), e.g., high-byte TAC (HBTAC) may be used to associate forecasts with network resources. Network resources may include, without limitation, local access resources, e.g., wireless access points, transport networks, and/or mobile core networks. In at least some embodiments, the network utilization and/or traffic forecasts may be provided to a network planner, who, in turn, may evaluate forecasted demand in view of current and/or planned network architectures. It is envisioned that in at least some embodiments, the network planner may identify network modifications, expansions and/or other enhancements to address potential shortfalls. In at least some embodiments, network modifications may include rerouting network traffic according to existing network resources, e.g., directing traffic from an overloaded network resource to another network resource that may have spare capacity.

FIG. 2G depicts an illustrative embodiment of an example, non-limiting embodiment of a mobile network forecasting process 300 in accordance with various aspects described herein. According to the example process 300, detailed market forecasts are obtained at 301. In at least some embodiments, the detailed market forecasts may correspond to the constrained, component forecasts obtained according to the previous example process 280 (FIG. 2F).

According to the example process, the process performs device technology forecasting at 302 based on the detailed market forecasts, e.g., the constrained market level and/or site level forecasts obtained at 301. In at least some embodiments, the device technology forecasting 302 generates one or more site-level forecasts at 303. For example, the site-level forecasts may be determined as lower-level forecasts of a market level forecast that may encompass multiple sites. An iterative reconciliation algorithm may be applied by adjusting combinations of site level forecasts until a satisfactory agreement is reached for a corresponding market level forecast. To the extent a site may include a wireless access point having multiple faces, the process may generate separate unconstrained, face-level forecasts for each of the faces at 304. The unconstrained face level forecasts may be constrained according to the site-level forecast, e.g., by applying yet another iterative reconciliation algorithm between the site-level forecast and the face-level forecasts.

In at least some embodiments, one or more busy hour forecasts may be determined at 312 for one or more of the constrained market level forecasts, the constrained site level forecasts and/or the constrained, face-level forecasts. Alternatively, or in addition, existing access point infrastructure may be evaluated at 306 according to the constrained site-level forecasts and/or the constrained face-level forecasts. The evaluation may assess the adequacy of existing site resources in view of the current forecasts. To the extent the existing resources are determined to be inadequate, a site access development and/or reconfiguration plan may be prepared according to differences between existing site resources and one or more of the example constrained site forecasts and/or constrained face-level forecasts.

In at least some embodiments, the example process 300 performs QCI forecasting at 307. According to the QCI forecasting, a proximity of USIDs may be generated at 308. For example, the proximity mapper 272 may generate one or more proximity maps based on the validated site and/or face level forecasts and/or from integrated historical traffic actuals data. The proximity maps may identify USIDs proximity to a particular location and/or region, such as a cell site, a face, a cell coverage area and/or sector, and the like. Face-level QCI models may be generated at 309 for each of the faces of a particular site. Unconstrained face-level QCI forecasts may be generated at 310, while constrained face-level QCI forecasts may be generated at 311. For example, the constrained face-level QCI forecasts may be constrained according to a corresponding market-level forecast. It is understood that in at least some embodiments, the constrained face-level QCI forecasts may be considered in any access point infrastructure evaluated at 306, such that the QCI forecasts may be considered in any site access development and/or reconfiguration plan.

While for purposes of simplicity of explanation, the respective processes are shown and described as a series of blocks in FIGS. 2F and 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2H is a block diagram illustrating an example, non-limiting embodiment of a forecast reconciliation processing system 2000 which can function within the communication network and/or systems of FIG. 1 2A, 2B, 2C, 2D and 2E in accordance with various aspects described herein. The forecast reconciliation processing system 2000 obtains forecast input data from a data source 2003. In at least some embodiments, the data source may include a data repository 221, 224 FIGS. 2B and 2C. Alternatively, or in addition, the data source 2003 may include an integrated historical records keeper 257 (FIG. 2D). The data source 2003 may include high-level data 2001, e.g., representative of a high-level or macro perspective of source data. Alternatively, or in addition, the data source 2003 may include lower-level data 2002, which may include separate data records from a number of lower-level perspectives of the source data. In at least some embodiments, the high-level data 2001 and/or the lower-level data 2002 may include multi-dimensional data that may be processed by the example forecast reconciliation processing system 2000 to yield one or more forecasts according to one or more dimensions of the multi-dimensional data. It is understood that the multi-dimensional data may include, without limitation, any data that may be forecasted, such as the example marketing data, including time series data, network utilization data, consumer equipment data, network configuration data, equipment location data, and so on.

The example forecast reconciliation processing system 2000 includes a macro forecast module 2004 that may be adapted to produce a high-level or macro forecast 2021, sometimes referred to as a “top-down” forecast, based on the high-level data 2001. In at least some embodiments, the forecast reconciliation processing system 2000 may include a first aggregator module 2005 (shown in phantom), that may be adapted to sum and/or otherwise combine data from one or more lower-levels of the lower-level data 2002 to obtain aggregated high-level data. The aggregated high-level data may be provided to the macro forecast module 2004 to obtain a macro forecast based on a combination of lower-level data. The macro forecast module 2004 may generate one or more forecasts based on any of the example techniques disclosed herein and/or otherwise generally known to predict future performance based on observations of past performance, including trend analysis, modeling, and so on.

In at least some embodiments, the macro forecaster module 2004 may receive one or more additional inputs that may be considered by the macro forecaster module 2004 in generating the macro forecast 2021. According to the illustrative embodiment, the additional information is referred to as high-level insight(s) 2006, such that the macro forecast may be based on the high-level and/or aggregated lower-level data, the additional input(s), e.g., the high-level insight(s) 2006, or a combination of both. By way of nonlimiting example, a high-level insight 2006 might identify rollout of a new product, such as one or more of a new smart phone device, a new mobile service plan, a new core network configuration, a strategic alliance, and so on. In such instances, the macro forecaster module 2004 may provide some adjustment and/or forecast offset based on historical records, to obtain an adjusted forecast that takes into consideration the high-level insight. In some instances, the offset may be identified in the high-level insight(s) 2006, e.g., an anticipated increase in data utilization and/or subscriber base of some percentage value. Alternatively, or in addition, the forecast offset may be estimated based on past observations of forecast accuracies based on prior, similar high-level insight(s) 2006.

It is envisioned that in at least some embodiments, the forecast reconciliation processing system 2000 may include a macro forecast adjuster module 214 (shown in phantom). The macro forecast adjuster module 214 may be configured to adjust a performance of the macro forecaster module 2004 and/or a macro forecast output of the macro forecaster module 2004. In at least some embodiments, such macro adjustments may be based on one or more of prior forecasts of the same or similar high-level and/or aggregated lower-level data 2001, 2002, and/or forecasts of other data sets. In at least some embodiments, the macro forecast adjuster module 214 may employ feedback, e.g., according to a feedback loop that may be configured to improve subsequent macro forecasts.

The example forecast reconciliation processing system 2000 also includes a lower-level forecasting module 2020. The lower-level forecasting module 2020 may be configured to produce individual or separate, lower-level forecasts based on lower-level data 2002. According to the illustrative example, the lower-level forecasting module 2020 include some number, N, lower-level forecast modules 2007a . . . 2007n, generally 2007. Each lower-level forecast module 2007 may receive a respective portion of lower-level data 2002 as appropriate according to the number and/or types of hierarchical levels of data. Each lower-level forecast module 2007 is configured to generate a lower-level forecast based on the respective portion of the lower-level data 2002. In at least some embodiments, one or more of the lower-level forecast modules 2007 may receive one or more additional inputs, such as the example lower-level insights 2008a 2008n, generally 2008. In such instances, the lower-level forecasts may be based on the respective portions of the lower-level data 2002, the lower-level insight(s), or a combination of both.

In at least some embodiments, the forecast reconciliation processing system 2000 includes a second aggregator module 2009, that may be adapted to sum and/or otherwise combine lower-level forecasts from one or more lower-level forecast modules 2007 to obtain aggregated lower-level forecasts 2022, sometimes referred to as a “bottoms-up” forecast. The aggregated lower-level forecasts 2022 may be referred to as unconstrained in that it does not depend on the macro forecast 2021. In at least some embodiments, the high-level data corresponds to an aggregation of the lower-level data. Similarly, the macro forecast 2021 may correspond to the aggregated lower-level forecasts 2022. For example, the two types of forecasts 2021, 2022 may correspond to a desired forecast quantity, with each derived according to a different technique. It is understood that the macro forecast 2021 may differ to at least some degree from the aggregated lower-level forecasts in that they may have taken account of different insights and/or different predictions based on their respective input data.

In at least some embodiments, the forecast reconciliation processing system 2000 includes a comparator module 2010. The comparator module 2010 may receive the macro forecast 2021 and the aggregated lower-level forecasts 2022 and determine some measure of comparison therebetween. Comparisons may be determined according to a difference, a ratio, a percentage, and the like. According to the illustrative example, the comparator module 2010 may provide a comparator output, e.g., a forecast offset or error 2023, indicative of a measure of a difference between the two types of forecasts 2021, 2022. To the extent the forecasts 2021, 2022 are similar, the measure of the difference will be relatively low, trending towards some low value, e.g., zero.

It is understood that the forecast reconciliation processing system 2000 may be operated in an iterative manner to refine and/or otherwise adjust or offset the lower-level forecasts. Such refinements may be determined and/or otherwise implemented in a sequence of iterations, such that the forecast error 2023 is reduced in subsequent iterations. In at least some embodiments, the forecast reconciliation processing system 2000 includes a feedback look having an error evaluation module 2011 that receives the forecast error 2023 from the comparator module 2010 and determines whether the error falls within some acceptable range, e.g., below an error threshold. To the extent the error evaluation module 2011 determines that the error is unacceptable, suggesting that further iterations should be attempted, the error evaluation module 2011 informs the offset generator 2012. The offset generator 2012, in turn, generates one or more offset parameters that may be provided, respectively, to each of the lower-level forecast modules 2007. The lower-level forecast modules 2007 may be configured to revise prior level forecasts, e.g., according to a respective offset parameter. Alternatively, or in addition, the lower-level forecast modules 2007 may be configured to provide forecasts based on the lower-level data 2002, the lower-level insights 2008 and the offset parameters. In either instance, the lower-level forecast modules 2007 produce revised lower-level forecasts. Such revised lower-level forecasts may be referred to as being constrained, e.g., in that they depend to at least some degree on the macro forecast 2021. For example, the offset generator 2012 may generate offset parameters in a manner that apportions the forecast error 2023 to the lower levels.

The forecast reconciliation processing system 2000 may combine the revised lower-level forecasts in the second aggregator module 2009 to obtain a revised aggregated lower-level forecast 2022. The comparator module 2010 may compare the revised aggregated lower-level forecast 2022 to the macro forecast 2021 to obtain a revised forecast offset or error 2023. The process may continue until the error evaluation module 2011 determines that the offset or error 2023 is acceptable, or after some maximum or limiting number of iterations, upon which the error evaluation module 2011 may inform the lower-level forecasting module 2020. The lower-level forecasting module 2020, having been informed that the constrained lower-level forecasts satisfy the error criteria, may provide their respective lower-level forecasts as completed, constrained lower-level forecasts 2013a . . . 2013n, generally 2013. It is understood that the forecast reconciliation processing system 2000 may be applied to different applications and/or to different levels within a multi-level application. For example, a macro forecast of utilization of a mobile network may represent a national and/or a global forecast, while a lower-level forecast may represent a market level forecast, a LoB forecast, and so on. Alternatively, or in addition, the lower-level forecasts may be considered as macro forecasts, when the lower-level forecasts may be subdivided further. For example, each market level forecast may be considered as a macro forecast, while lower-level forecasts may be obtained for sub-regions within a market and/or for individual mobile access points or cell sites. Still further, cell site forecasts may be considered as macro forecasts, while lower-level forecasts may be obtained for sectors and/or faces of each cell site.

Referring now to FIG. 2I, various steps of a method 2100 according to an embodiment are shown. As seen in this FIG. 2I, step 2102 comprises obtaining first historical data indicative of a first mix of wireless device communication technologies that have been used to communicate with a first plurality of access points in a first market. Next, step 2104 comprises obtaining first characterizing information indicative of a first characteristic of the first market. Next, step 2106 comprises obtaining second historical data indicative of a second mix of wireless device communication technologies that have been used to communicate with a second plurality of access points in a second market, wherein the second market is different from the first market. Next, step 2108 comprises obtaining second characterizing information indicative of a second characteristic of the second market. Next, step 2110 comprises obtaining third characterizing information indicative of a third characteristic of a third market, wherein the third market is different from the first market and the second market. Next, step 2112 comprises determining, based at least in part upon the first, second, and third characterizing information, to which of the first characteristic or the second characteristic the third characteristic more closely matches. Next, step 2114 comprises: in a first case that the first characteristic more closely matches the third characteristic, generating based at least in part upon the first historical data a first forecast of a first future mix of wireless device communication technologies that will be used to communicate with a third plurality of access points in the third market; or in a second case that the second characteristic more closely matches the third characteristic, generating based at least in part upon the second historical data a second forecast of a second future mix of wireless device communication technologies that will be used to communicate with the third plurality of access points in the third market. In various embodiments, a forecast can be further based upon one or more prior known historical datasets (e.g., from one or more selected markets, regions, or the like). In other embodiments, the first market can be any first geographically bounded area, the second market can be any second geographically bounded area, the third market can be any third geographically bounded area, or any combination thereof.

While for purposes of simplicity of explanation, the respective processes are shown and described as a series of blocks in FIG. 2I, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2J, various steps of a method 2200 according to an embodiment are shown. As seen in this FIG. 2J, step 2202 comprises obtaining first traffic flow information indicative of a first mix of end user device types that have been used to communicate with a first plurality of access points in a first market. Next, step 2204 comprises obtaining first characterization data indicative of a first characteristic of the first market. Next, step 2206 comprises obtaining second traffic flow information indicative of a second mix of end user device types that have been used to communicate with a second plurality of access points in a second market. Next, step 2208 comprises obtaining second characterization data indicative of a second characteristic of the second market. Next, step 2210 comprises obtaining third characterization data indicative of a third characteristic of a third market, wherein each of the first, second, and third markets are different markets. Next, step 2212 comprises determining, based at least in part upon the first, second, and third characterization data, to which of the first characteristic or the second characteristic the third characteristic more closely corresponds. Next, step 2214 comprises: in a first case that the first characteristic more closely corresponds to the third characteristic, generating based at least in part upon the first traffic flow information a first forecast of a first future mix of end user device types that will be used to communicate with a third plurality of access points in the third market; or in a second case that the second characteristic more closely corresponds to the third characteristic, generating based at least in part upon the second traffic flow information a second forecast of a second future mix of end user device types that will be used to communicate with the third plurality of access points in the third market. In various embodiments, a forecast can be further based upon one or more prior known historical datasets (e.g., from one or more selected markets, regions, or the like). In other embodiments, the first market can be any first geographically bounded area, the second market can be any second geographically bounded area, the third market can be any third geographically bounded area, or any combination thereof

While for purposes of simplicity of explanation, the respective processes are shown and described as a series of blocks in FIG. 2J, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2K, various steps of a method 2300 according to an embodiment are shown. As seen in this FIG. 2K, step 2302 comprises obtaining, by a processing system including a processor, first time series data indicative of a first mix of end-user device wireless communication technologies that that have been used to communicate with one or more faces of a first base station in a first market. Next, step 2304 comprises obtaining, by the processing system, second time series data indicative of a second mix of end-user device types that that have been used to communicate with the one or more faces of the first base station in the first market. Next, step 2306 comprises obtaining, by the processing system, first information indicative of a first characteristic of the first market. Next, step 2308 comprises obtaining, by the processing system, third time series data indicative of a third mix of end-user device wireless communication technologies that that have been used to communicate with one or more faces of a second base station in a second market. Next, step 2310 comprises obtaining, by the processing system, fourth time series data indicative of a fourth mix of end-user device types that that have been used to communicate with one or more faces of the second base station in the second market. Next, step 2312 comprises obtaining, by the processing system, second information indicative of a second characteristic of the second market. Next, step 2314 comprises obtaining, by the processing system, third information indicative of a third characteristic of a third market, wherein each of the first, second, and third markets are different markets, and wherein the third market includes a third base station. Next, step 2316 comprises determining by the processing system, based at least in part upon the first, second, and third information, to which of the first characteristic or the second characteristic the third characteristic more closely corresponds. Next, step 2318 comprises (I) in a first case that the first characteristic more closely corresponds to the third characteristic: generating, by the processing system, based at least in part upon the first time series data a first forecast of a first future mix of end-user device wireless communication technologies that will be used to communicate with one or more faces of the third base station; and generating, by the processing system, based at least in part upon the second time series data a second forecast of a first future mix of end-user device types that will be used to communicate with the one or more faces of the third base station; or (II) in a second case that the second characteristic more closely corresponds to the third characteristic: generating, by the processing system, based at least in part upon the third time series data a third forecast of a second future mix of end-user device wireless communication technologies that will be used to communicate with the one or more faces of the third base station; and generating, by the processing system, based at least in part upon the fourth time series data a fourth forecast of a second future mix of end-user device types that will be used to communicate with the one or more faces of the third base station. In various embodiments, a forecast can be further based upon one or more prior known historical datasets (e.g., from one or more selected markets, regions, or the like). In other embodiments, the first market can be any first geographically bounded area, the second market can be any second geographically bounded area, the third market can be any third geographically bounded area, or any combination thereof.

While for purposes of simplicity of explanation, the respective processes are shown and described as a series of blocks in FIG. 2K, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, various embodiments provide for multi-directional cell site device technology traffic forecasting-as-a-service. In various examples, the devices can include internet-of-things (IoT), gaming, vehicle, or any combination thereof.

As described herein, various embodiments provide for mobility forecasting.

As described herein, various embodiments provide for an integrated forecasting system. The integrated forecasting system can take one or more inputs to enable reconciliation of a local level device technology forecast to an official forecast. The official forecast can include inputs from marketing, product, or other experts on expected sales or demand at a national level by product and Quality of Service, overlays of expected variation from this initial view, and can account for any expected changes in infrastructure.

As described herein, various embodiments provide for an integrated forecasting system in which the forecasted traffic is distributed by Market, Device technology, and/or Quality of Service.

As described herein, various embodiments provide for an integrated forecasting system that utilizes a localized site/sector level forecast module. In various examples, an historical traffic time series at a site and sector can be used to assess the type of site (for instance-Is it new with limited history? Is its traffic seasonal?). This data can be used to generate an unconstrained traffic forecast based on the historical traffic time series. In addition, the historical trends (e.g., of the 4G/5G device technology mix and the uplink/downlink traffic mix) at the local level can be used to generate forecasts for those dimensions. In various examples, one or more new sites with insufficient history can “borrow” trends from one or more nearby sites (in one specific example, seasonal traffic sites will maintain that seasonality). In one example, the aggregated forecasts at a market level are then constrained to the market forecast.

As described herein, various embodiments provide for an integrated forecasting system that answers the questions of: (a) How much traffic is expected at a local level? (b) What level of RAN capacity would be adequate at a given location? (c) How much of the traffic will be 4G vs 5G vs 6G? (d) How much of the traffic will be in the uplink direction rather than the downlink direction? (e) How is the traffic expected to grow over time? (f) Any combination of the above. In one specific example, a forecasted time series can be generated for these elements.

As described herein, various embodiments provide for an integrated forecasting system in which a market forecast is non-uniformly applied to each face direction of each cell site in a market.

As described herein, various embodiments provide a bottom-up approach (e.g., using localized site/sector level historical actuals by device technology to develop a localized forecast). If (for example) new technology is present on a site, a traffic inflation factor can be considered (e.g., 5G phone apps may use more traffic than 4G phone apps; C Band may allow more traffic throughput).

As described herein, various embodiments provide algorithms to detect trends and treat sites/sectors accordingly (e.g., each new site may “borrow” a trend from one or more nearby sites (in one specific example, seasonal sites will keep their seasonal trend)).

As described herein, various embodiments provide for constraining the aggregation of the face level forecasts by the top-down market forecast view to be in sync with the official view. In various examples, algorithms can be used to validate forecasts (e.g., 4G traffic declines while 5G traffic increases, dealing with missing data, etc.).

As described herein, various embodiments provide for an integrated forecasting system to generate device technology forecasts, Line of Business forecasts, and/or Network Slice forecasts.

As described herein, various embodiments provide for an integrated forecasting system that can be used in the context of worldwide Mobility Traffic Forecasting, broadband/internet providers, power distribution planning, water distribution planning, or any combination thereof.

As described herein, various embodiments facilitate: (a) properly assessing capacity needs—for instance to make certain not to under build the network and disappoint customers with poor performance; and/or (b) properly assessing capacity needs—for instance (from a capital expenditure perspective) not to over build and use/strand capital too early.

As described herein, various embodiments provide for an integrated forecasting system that can be used by one or more mobility companies, internet providers, power companies, water distribution companies, or any combination thereof.

As described herein, various embodiments provide for use in a context where one must forecast demand at localized level. In various examples, mobility demand can be forecast at a cell site sector/face level. In various examples, localized demand forecasts can be made for: (a) wireline Internet traffic; (b) electric power demand; (c) water demand; and/or (d) any combination thereof.

As described herein, various embodiments provide global traffic forecasting as a service for one or more of: (a) mobility traffic (including IoT); (b) wireline/internet traffic; (c) power consumption; (d) water consumption; and/or (e) any combination thereof.

As described herein, various embodiments provide national, market, and regional forecasting to get to Line of Business (LoB), market, device technology, QoS, and/or infrastructure forecasts. This can be accomplished, for example, by one or more automated data and forecasting processes including: (a) historical actuals data anomaly detection; (b) upload error checking; (c) iterative reconciliation algorithm; (d) data proxies; (e) data transformations; (f) exponential smoothing; (g) locally weighted smoothing; (h) wMAPE; (i) central data repository; (j) any combination thereof. Various benefits include improved forecast quality and cycle time for downstream capacity planning.

As described herein, various embodiments provide global traffic forecasting in the context of: (a) 3G, 4G, 5G with UL/DL KB, MOU, 6G; (b) any desired number of QCI (e.g., 6-9) & voice with 4G&5G, UL/DL.

As described herein, various embodiments provide site level forecasting that can utilize millions of access point/QoS forecasts. Such forecasting can be accomplished, for example, by one or more automated data and forecasting processes including: (a) anomaly detection; (b) time series seasonality decomposition and detection; (c) regression; (d) exponential smoothing; (e) kernel method for local weights; (f) distributed lag/auto-regressive model; (g) moving average trending; (h) nearest neighbor pooling for robust trending; (i) generalized additive models; (j) locally polynomial quantile regression; (k) ensemble models; (l) any combination thereof. Various benefits include improved forecast quality and cycle time for downstream capacity planning.

As described herein, various embodiments provide global traffic forecasting in the context of one or more new offer scenarios.

As described herein, various embodiments provide for demand forecasting at a sector/face level (e.g., for more precision and granularity than can be provided by forecasting only at a market level). In one specific example, each sector/face on a cell site can have an individual, tailored, growth forecast.

As described herein, various embodiments provide for capacity planning that can be localized (e.g., site/face/sector).

As described herein, various embodiments can take into account a situation in which site/face/sectors in the same market can experience very different growth (demand).

As described herein, various embodiments provide forecasting for a site location and direction (e.g., a geographical coverage area that consists of multiple sectors (which can be of various technologies)).

As described herein, various embodiments provide seasonal forecasting (e.g., wherein a seasonal index is utilized to make a determination as to classification as a seasonal face for a particular time period). In one specific example, a face can be classified as seasonal if there is a peak usage during the same month in 2 or more prior years. In one specific example, a seasonal forecast can: (a) utilize a smoothed trend to determine future growth; and/or (b) add back a seasonal component to generate a final forecast.

As described herein, various embodiments provide for a forecasting process comprising: (a) receiving face information; (b) inputting the face information (in the case of one or more new sites with less than, for example, 12 month history) to a neighborhood method to generate neighborhood method output; (c) inputting the face information (in the case of sufficient history) to a trend/seasonal decomposition method to generate trend/seasonal decomposition output; (d) inputting the trend/seasonal decomposition output to a robust seasonal factors method to generate robust seasonal factors output and to a robust trend estimation total method to generate robust trend estimation total output; (e) inputting the neighborhood method output, the robust seasonal factors output, and the robust trend estimation total output to a combined trend and seasonal method to generate combined trend and seasonal output; (f) input the combined trend and seasonal output to a 4G/5G trend method to generate 4G/5G trend output; (g) input the 4G/5G trend output to a UL/DL trend method to generate UL/DL trend output; (h) input the UL/DL trend output to a split method (which receives one or more market forecasts) to generate split output by applying market level proportion to create a 4G/5G split for sites with no 5G actuals; (i) input the split output to a market level forecast method to generate one or more (e.g., monthly) forecasts.

As described herein, various embodiments can provide a localized bottom-up forecast constrained by a top-down forecast. In one specific example, a zip code mapping can be used as an input to determine USID level volumes which (along with USID-level weighting data by reseller and pre-paid/post-paid breakdowns) can be used to determine traffic distribution. Such traffic distribution can in turn be used to generate various forecasts (e.g., RAN submarket/market, and/or QCI forecast overlay (e.g., X % QCI9 and Y % QCI8)). In various embodiments, with a new product having no traffic history, proxies can be identified in order to estimate a likely forecast.

As described herein, various embodiments can provide a localized bottom-up forecast constrained by a top-down forecast (in the context of uplink/downlink percentages and/or wired communication paths).

As described herein, various embodiments can provide a localized bottom-up forecast constrained by a top-down forecast (in the context of uplink/downlink percentages and/or wireless communication paths).

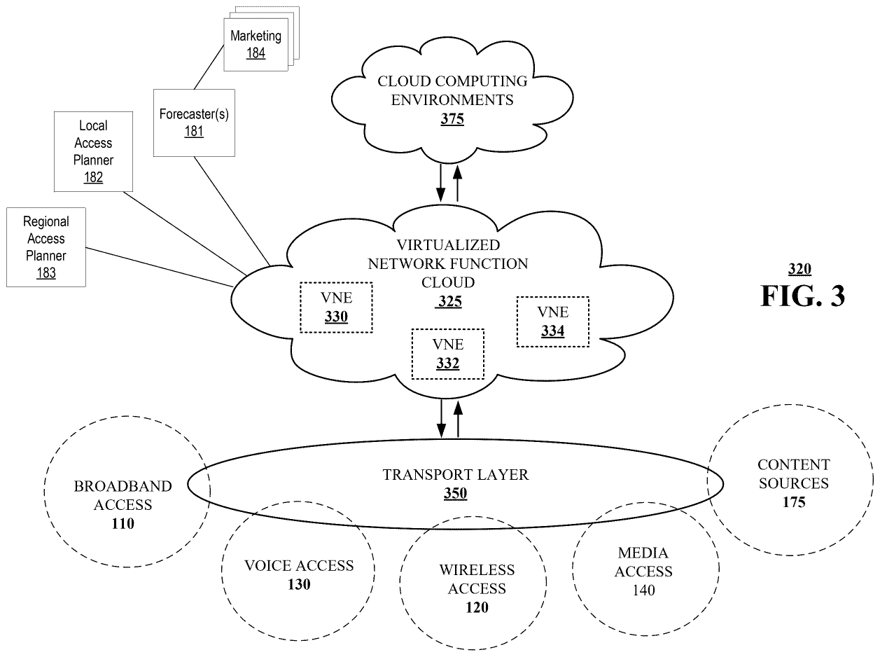

Referring now to FIG. 3, a block diagram is shown illustrating an example, non-limiting embodiment of a virtualized communication network 320 in accordance with various aspects described herein. In particular, a virtualized communication network is presented that can be used to implement some or all of the subsystems and functions of system 100, the subsystems and functions of systems 200, 210, 230, 240, 260 and processes 280, 300, 2000, 2100, 2200 presented in FIGS. 1, 2A through 2J and 3. For example, virtualized communication network 320 can facilitate in whole or in part combining multiple observations of actual network utilization within multiple areas to obtain a combination of network utilization and generating a high-level forecast based on the combination. Separate forecasts may be generated for each of the multiple areas and combined to obtain a combination of the separate area network utilization forecasts. The high-level forecast may then be compared with the combination of the separate area network utilization forecasts to obtain a difference. The difference may be compared to a threshold and, responsive to the comparison, at least one separate area network utilization forecast may be adjusted according to the baseline forecast. In various embodiments, the forecasting can relate to device/site technology.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall, which creates an elastic function with higher availability than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third party locations.

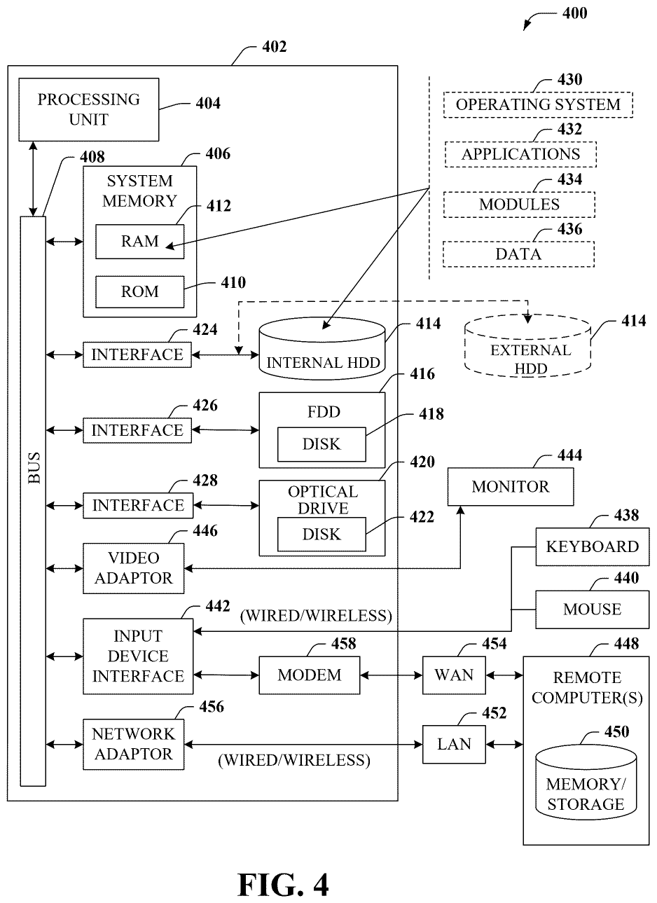

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part combining multiple observations of actual network utilization within multiple areas to obtain a combination of network utilization and generating a high-level forecast based on the combination. Separate forecasts may be generated for each of the multiple areas and combined to obtain a combination of the separate area network utilization forecasts. The high-level forecast may then be compared with the combination of the separate area network utilization forecasts to obtain a difference. The difference may be compared to a threshold and, responsive to the comparison, at least one separate area network utilization forecast may be adjusted according to the baseline forecast. In various embodiments, the forecasting can relate to device/site technology.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All, or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen and the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

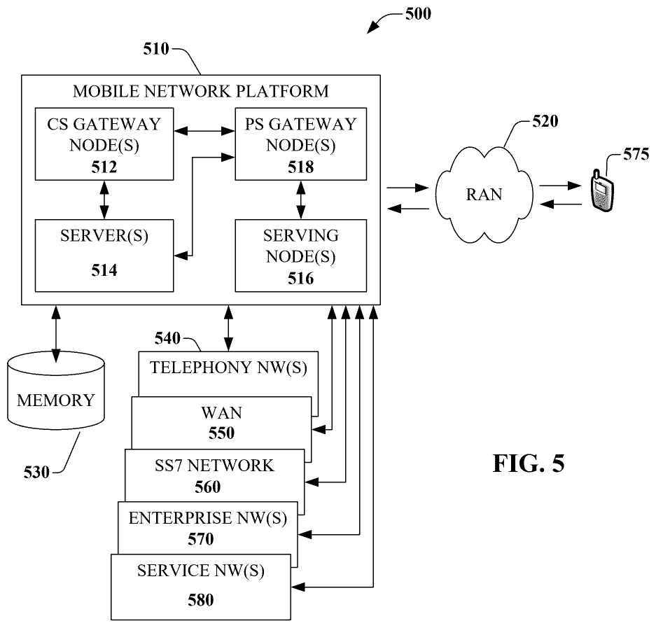

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part combining multiple observations of actual network utilization within multiple areas to obtain a combination of network utilization and generating a high-level forecast based on the combination. Separate forecasts may be generated for each of the multiple areas and combined to obtain a combination of the separate area network utilization forecasts. The high-level forecast may then be compared with the combination of the separate area network utilization forecasts to obtain a difference. The difference may be compared to a threshold and, responsive to the comparison, at least one separate area network utilization forecast may be adjusted according to the baseline forecast. In various embodiments, the forecasting can relate to device/site technology. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

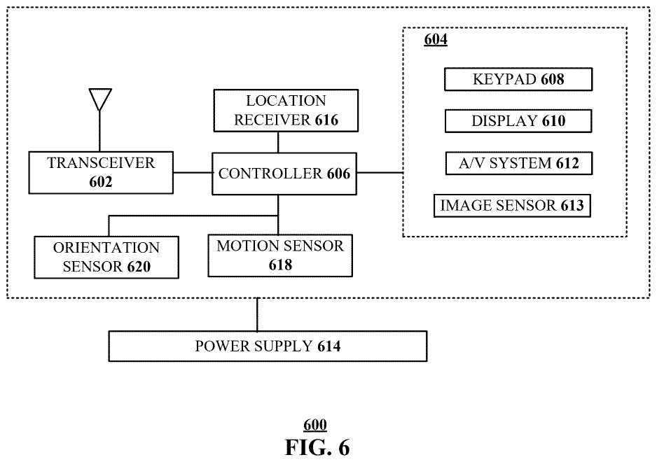

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part combining multiple observations of actual network utilization within multiple areas to obtain a combination of network utilization and generating a high-level forecast based on the combination. Separate forecasts may be generated for each of the multiple areas and combined to obtain a combination of the separate area network utilization forecasts. The high-level forecast may then be compared with the combination of the separate area network utilization forecasts to obtain a difference. The difference may be compared to a threshold and, responsive to the comparison, at least one separate area network utilization forecast may be adjusted according to the baseline forecast. In various embodiments, the forecasting can relate to device/site technology.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

Although many of the examples provided herein refer to communication networks, it is understood that the techniques may be applied more generally to forecasting sales, provision and/or consumption of any product or resource within multiple markets. Other example applications may include, without limitation, sales of consumer products and/or services, distribution of a utility, such as energy, e.g., electricity and/or natural gas, and/or water, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data, including a forecasting of a network resource as may be performed as-a-service, can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) and/or machine learning to facilitate automating one or more features described herein, such as the forecasting (e.g., as related to device/site technology) of a network resource as may be performed as-a-service, including any one or more of the aforementioned example techniques applied to the obtaining, the evaluating, the revising, the updating and/or the improving such forecasts. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network and/or a forecasting (e.g., as related to device/site technology) of a network resource, e.g., a network configuration, a network utilization, a network capacity, a network quality of service. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions (e.g., as related to device/site technology), including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
obtaining first historical data indicative of a first mix of wireless device communication technologies that have been used to communicate with a first plurality of access points in a first market;
obtaining first characterizing information indicative of a first characteristic of the first market;
obtaining second historical data indicative of a second mix of wireless device communication technologies that have been used to communicate with a second plurality of access points in a second market, wherein the second market is different from the first market;
obtaining second characterizing information indicative of a second characteristic of the second market;
obtaining third characterizing information indicative of a third characteristic of a third market, wherein the third market is different from the first market and the second market;
determining, based at least in part upon the first, second, and third characterizing information, to which of the first characteristic or the second characteristic the third characteristic more closely matches;
in a first case that the first characteristic more closely matches the third characteristic, generating based at least in part upon the first historical data a first forecast of a first future mix of wireless device communication technologies that will be used to communicate with a third plurality of access points in the third market; and
in a second case that the second characteristic more closely matches the third characteristic, generating based at least in part upon the second historical data a second forecast of a second future mix of wireless device communication technologies that will be used to communicate with the third plurality of access points in the third market.

2. The device of claim 1, wherein:
the first market comprises a first geographic area that has a first size;
the second market comprises a second geographic area that has a second size; and
the third market comprises a third geographic area that has a third size, wherein the third size is smaller than each of the first size and the second size.

3. The device of claim 1, wherein:
the first market comprises a first number of subscribers;
the second market comprises a second number of subscribers; and
the third market comprises a third number of subscribers, wherein the third number of subscribers is smaller than each of the first number of subscribers and the second number of subscribers.

4. The device of claim 1, further comprising:
in the first case, facilitating a first change in wireless communication network resources in the third market based at least in part upon the first forecast; and
in the second case, facilitating a second change in wireless communication network resources in the third market based at least in part upon the second forecast.

5. The device of claim 4, wherein:
in the first case:
the first change comprises a first increase of resources to provide more support for one or more first particular wireless communication technologies based upon the first forecast;
the first change comprises a first decrease of resources to provide less support for one or more second particular wireless communication technologies based upon the first forecast; or
any first combination thereof; and
in the second case:
the second change comprises a second increase of resources to provide more support for one or more third particular wireless communication technologies based upon the second forecast;
the second change comprises a second decrease of resources to provide less support for one or more fourth particular wireless communication technologies based upon the second forecast; or
any second combination thereof.

6. The device of claim 1, wherein each of the wireless device communication technologies comprises: fourth-generation (4G) cellular, fifth-generation (5G) cellular, sixth-generation (6G) cellular, any later generation cellular, LTE cellular, WI-FI, or any combination thereof.

7. The device of claim 1, wherein each of the first, second, and third plurality of access points comprises a respective one of: a macro base station, a micro base station, a WI-FI node, or any combination thereof.

8. The device of claim 1, wherein each of the wireless devices comprises a respective end user mobile communication device.

9. The device of claim 8, wherein each of the end user mobile communication devices comprises a respective one of: a smartphone, a cellular phone, a tablet computer, a laptop computer, or any combination thereof.

10. The device of claim 1, wherein each of the first, second and third characteristics comprises a respective one of: a geographic size of the respective market, a geographic location of the respective market, a ZIP code of the respective market, a political subdivision of the respective market, a number of subscribers in the respective market, a number of pre-paid subscribers in the respective market, a number of post-paid subscribers in the respective market, a percent of pre-paid subscribers versus a total number of subscribers in the respective market, a percent of post-paid subscribers versus a total number of subscribers in the respective market, a percent of pre-paid subscribers versus a number of post-paid subscribers in the respective market, an amount of audio network traffic in the respective market, an amount of video network traffic in the respective market, a percent of audio network traffic versus total network traffic in the respective market, a percent of video network traffic versus total network traffic in the respective market, a percent of audio network traffic versus a percent of video network traffic in the respective network, an average age of subscribers in the respective market, an age range of subscribers in the respective market, or any combination thereof.

11. The device of claim 1, wherein:
the first characteristic more closely matching the third characteristic comprises the first characteristic having a respective numerical value that is closer to a respective numerical value of the third characteristic than is a respective numerical value of the second characteristic; and
the second characteristic more closely matching the third characteristic comprises the second characteristic having a respective numerical value that is closer to a respective numerical value of the third characteristic than is a respective numerical value of the first characteristic.

12. The device of claim 1, wherein:
the first characteristic comprises a first plurality of characteristics;
the second characteristic comprises a second plurality of characteristics; and
the third characteristic comprises a third plurality of characteristics.

13. The device of claim 12, wherein:
the first characteristic more closely matching the third characteristic comprises a first number of the first plurality of characteristics that match the third plurality of characteristics being greater than a second number of the second plurality of characteristics that match the third plurality of characteristics; and
the second characteristic more closely matching the third characteristic comprises a third number of the second plurality of characteristics that match the third plurality of characteristics being greater than a fourth number of the first plurality of characteristics that match the third plurality of characteristics.

14. A non-transitory machine-readable medium comprising executable instructions that, when executed by a processing system including a processor, facilitate performance of operations, the operations comprising:
obtaining first traffic flow information indicative of a first mix of end user device types that have been used to communicate with a first plurality of access points in a first market;
obtaining first characterization data indicative of a first characteristic of the first market;
obtaining second traffic flow information indicative of a second mix of end user device types that have been used to communicate with a second plurality of access points in a second market;
obtaining second characterization data indicative of a second characteristic of the second market;
obtaining third characterization data indicative of a third characteristic of a third market, wherein each of the first, second, and third markets are different markets;
determining, based at least in part upon the first, second, and third characterization data, to which of the first characteristic or the second characteristic the third characteristic more closely corresponds;
in a first case that the first characteristic more closely corresponds to the third characteristic, generating based at least in part upon the first traffic flow information a first forecast of a first future mix of end user device types that will be used to communicate with a third plurality of access points in the third market; and
in a second case that the second characteristic more closely corresponds to the third characteristic, generating based at least in part upon the second traffic flow information a second forecast of a second future mix of end user device types that will be used to communicate with the third plurality of access points in the third market.

15. The non-transitory machine-readable medium of claim 14, wherein:
each of the first plurality of access points comprises a first macro base station, a first micro base station, a first WI-FI node, or any first combination thereof;
each of the second plurality of access points comprises a second macro base station, a second micro base station, a second WI-FI node, or any second combination thereof; and
each of the third plurality of access points comprises a third macro base station, a third micro base station, a third WI-FI node, or any third combination thereof.

16. The non-transitory machine-readable medium of claim 14, wherein:
each end user device corresponding to the first mix of end user device types comprises a respective one of: a smartphone, a cellular phone, a tablet computer, a laptop computer, an internet-of-things (IoT) device, a gaming device, a vehicle, or first any combination thereof;
each end user device corresponding to the second mix of end user device types comprises a respective one of: a smartphone, a cellular phone, a tablet computer, a laptop computer, an internet-of-things (IoT) device, a gaming device, a vehicle, or any second combination thereof;
in the first case, each end user device type corresponding to the first future mix of end user device types comprises a respective one of: a smartphone, a cellular phone, a tablet computer, a laptop computer, an internet-of-things (IoT) device, a gaming device, a vehicle, or any third combination thereof; and
in the second case, each end user device type corresponding to the second future mix of end user device types comprises a respective one of: smartphone, a cellular phone, a tablet computer, a laptop computer, an internet-of-things (IoT) device, a gaming device, a vehicle, or any fourth combination thereof.

17. The non-transitory machine-readable medium of claim 14, wherein the third market is smaller, both in number of subscribers and geographic area, than each of the first market and the second market.

18. A method comprising:
obtaining, by a processing system including a processor, first time series data indicative of a first mix of end-user device wireless communication technologies that have been used to communicate with one or more faces of a first base station in a first market;
obtaining, by the processing system, second time series data indicative of a second mix of end-user device types that have been used to communicate with the one or more faces of the first base station in the first market;
obtaining, by the processing system, first information indicative of a first characteristic of the first market;
obtaining, by the processing system, third time series data indicative of a third mix of end-user device wireless communication technologies that have been used to communicate with one or more faces of a second base station in a second market;
obtaining, by the processing system, fourth time series data indicative of a fourth mix of end-user device types that have been used to communicate with the one or more faces of the second base station in the second market;
obtaining, by the processing system, second information indicative of a second characteristic of the second market;
obtaining, by the processing system, third information indicative of a third characteristic of a third market, wherein each of the first, second, and third markets are different markets, and wherein the third market includes a third base station;
determining by the processing system, based at least in part upon the first, second, and third information, to which of the first characteristic or the second characteristic the third characteristic more closely corresponds;
in a first case that the first characteristic more closely corresponds to the third characteristic:
generating based at least in part upon the first time series data a first forecast of a first future mix of end-user device wireless communication technologies that will be used to communicate with one or more faces of the third base station; and
generating based at least in part upon the second time series data a second forecast of a first future mix of end-user device types that will be used to communicate with the one or more faces of the third base station; and
in a second case that the second characteristic more closely corresponds to the third characteristic:
generating based at least in part upon the third time series data a third forecast of a second future mix of end-user device wireless communication technologies that will be used to communicate with the one or more faces of the third base station; and
generating based at least in part upon the fourth time series data a fourth forecast of a second future mix of end-user device types that will be used to communicate with the one or more faces of the third base station.

19. The method of claim 18, wherein:
the one or more faces of the first base station comprise a first plurality of faces, each of which faces supports communication with a corresponding sector;
the one or more faces of the second base station comprise a second plurality of faces, each of which faces supports communication with a corresponding sector; and
the one or more faces of the third base station comprise a third plurality of faces, each of which faces supports communication with a corresponding sector.

20. The method of claim 18, wherein the determining is based upon one of: a machine learning process, an artificial intelligence process, or any combination thereof.
